(19) United States
(12) Patent Application Publication
(10) Pub. No.: US 2025/0132510 A1
(43) Pub. Date: Apr. 24, 2025

(54) WIRE TERMINALS

(71) Applicant: LEVITON MANUFACTURING CO., INC., Melville, NY (US)

(72) Inventors: Vikramsinh P. BHOSALE, Westbury, NY (US); Michael Mattei, Saint James, NY (US); Zachary Ednie, Farmingdale, NY (US)

(73) Assignee: LEVITON MANUFACTURING CO., INC., Melville, NY (US)

(21) Appl. No.: 18/708,763

(22) PCT Filed: Apr. 4, 2024
(86) PCT No.: PCT/US2024/023075

§ 371 Date: May 9, 2024

Related U.S. Application Data
(60) Provisional application No. 63/461,945, filed on Apr. 26, 2023.

(51) Int. Cl. H01R 4/48; H01R 9/24

(52) U.S. Cl. CPC H01R 4/483; H01R 4/4816; H01R 4/48455; H01R 9/2491; H01R 4/48275; H01R 4/4844

(57) ABSTRACT

The present disclosure relates to wire terminals and/or termination mechanisms arranged and configured for use with a wiring device. In particular, the present disclosure relates to wire terminals utilizing an actuator and a spring clamp. In some embodiments, the actuator is a rotary actuator. In use, in the second position, the actuator contacts an extended leg of the spring clamp to manipulate the spring clamp to facilitate insertion of an electrical wire therein. In the first position, the spring clamp secures the wire within the device and in contact with the electrical terminal of the wiring device. In some embodiments, the wiring device is selected from one of a plug and connector type device or a pin and sleeve type device.

### CROSS-REFERENCE TO RELATED APPLICATIONS

This is a non-provisional of, and claims the benefit of the filing date of, pending U.S. provisional patent application No. 63/461,945, filed Apr. 26, 2023, entitled “Wire Terminals,” the entirety of which application is incorporated by reference herein.

### TECHNICAL FIELD

The present disclosure is directed to wiring devices and, more particularly, to wiring devices such as, for example, plug and connectors, incorporating improved wire terminals or termination mechanisms (terms used interchangeably herein without the intent to limit) to facilitate easier and quicker installation in the field.

### BACKGROUND

Generally speaking, as will be readily appreciated by one of ordinary skill in the art, to route, install and otherwise use AC electrical power, manufactures produce many different kinds of devices. These devices are referred to herein as wiring devices. Examples of wiring devices include electrical receptacles, switches, dimmers, occupancy sensors, lighting fixtures, ground/arc fault circuit interrupters, and the like. Other forms of wiring devices include receptacles, plug and connectors, pin and sleeves, and the like. Such wiring devices can be configured as any suitable grade, such as residential, commercial, industrial, heavy-duty, extra heavy duty, and/or hospital grade.

In use, wiring devices are connected to the AC electrical power via wires/conductors (the terms wire and conductor may be used hereinafter synonymously), which can include solid core conductors and/or stranded wire conductors. A wire includes (or is considered to be) a conductive path for carrying the AC electrical power.

Wiring devices typically include wire termination terminals for terminating wires. Wire terminal types typically found on wiring devices include sets of line and load terminals and/or ground terminals. Each set of line and/or load terminals typically include individual phase and neutral terminals. Together these terminals, depending on the mechanical configuration, may be wired using one or more of several different common termination mechanisms/techniques where the mechanical configuration of the termination mechanisms typically dictates the technique used.

One such termination mechanism/technique typically involves stripping an end of the wire to expose at least a portion of the end of the wire and then wrapping the exposed portion of the wire around a terminal screw. The terminal screw is then tightened causing the head of the screw to secure the exposed wire between the head of the screw and a metallic plate (e.g., a brass terminal).

Moreover, generally speaking, one specific type of wiring device is referred to as a plug and connector. Plugs and connectors typically include plugs, connectors, receptacles, inlets, mechanical interlocks, etc. Herein, a single device having either pins or blades (e.g., a plug), female contacts (e.g., a connector), or both will be referred to as a plug and connector, respectively, which form a subset of wiring devices. Pin and sleeve devices are similar to other plugs and connectors except that the mating contacts take the form of pin and sleeves, as opposed to blades and female contracts, respectively.

Generally speaking, plugs and connectors including pin and sleeve type devices, may be used to supply electrical power in any suitable environment including outdoor, commercial, or industrial environments. Plug and connectors may be used to supply electrical power to any suitable load such as heavy equipment, for example, welders, motors, compressors, conveyors, portable tools, portable lighting, etc. In use, plug and connectors may provide electrical connections safe from dust and water. As such, plug and connectors may be designed to provide power connections that are safe and secure from the environment (e.g., moisture, dirt, grime, chemicals, etc.), prevent accidental disconnect under load, and ensure high strength durability.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a wiring device. The wiring device including a housing, an electrical terminal disposed at least partially within the housing, and a wire terminal arranged and configured to mechanically and electrically secure a line-voltage AC electrical wire to the electrical terminal. In some embodiments, the wire terminal includes an actuator moveable between a first position and a second position, and a spring clamp including an opening, the opening at least partially defining an electrical wire receiving space to selectively receive an electrical wire, the spring clamp including an extended leg extending therefrom, the extended leg configured to interact with the actuator. In the second position, the actuator interacts and biases the extended leg so that a portion of the spring clamp moves with respect to the electrical terminal to enlarge the electrical wire receiving space to allow an electrical wire to be received therein. In the first position, the actuator allows the portion of the spring clamp to return to an initial configuration, the initial configuration arranged and configured to reduce the electrical wire receiving space, wherein if an electrical wire is present, the electrical wire is biased into contact with the electrical terminal to securely retain the electrical wire within the electrical wire receiving space and in contact with the electrical terminal.

In some embodiments, the actuator is a rotary actuator arranged and configured to rotate between the first position and the second position.

In some embodiments, the rotary actuator includes a lever arm and a cam, the cam being rotationally offset from the lever arm, the cam being arranged and configured to contact the extended leg of the spring clamp when the rotary actuator is in the second position.

In some embodiments, when the rotary actuator is in the first position, the cam exerts a reduced contact force on the extended leg of the spring clamp to allow the spring clamp to bias the electrical wire into contact with the electrical terminal.

In some embodiments, when the rotary actuator is in the first position, the cam exerts no contact force on the extended leg of the spring clamp to allow the spring clamp to bias the electrical wire into contact with the electrical terminal.

In some embodiments, the cam is oriented an approximate ninety-degree angle relative to the lever arm.

In some embodiments, the wiring device further includes a secondary mechanical spring arranged and configured to contact the cam of the rotary actuator to bias the rotary actuator into the first position.

In some embodiments, the spring clamp further includes a first leg arranged and configured to contact the electrical terminal, a second leg having a first end coupled to an end of the first leg, and a third leg coupled to a second end of the second leg, the extended leg extending away from the third leg.

In some embodiments, the electrical terminal includes a tab formed thereon, the first leg includes an opening, the opening of the first leg arranged and configured to receive the tab to couple the spring clamp to the electrical terminal.

In some embodiments, the third leg includes the opening of the spring clamp, the opening of the spring clamp defining an inner surface, the inner surface arranged and configured to contact the electrical wire when in the first position.

In some embodiments, the inner surface of the opening of the spring clamp includes a sharpened edge portion arranged and configured to engage the electrical wire.

In some embodiments, a segment of the first leg extends through the opening of the spring clamp formed in the third leg.

In some embodiments, moving the extended leg moves the third leg relative to the first leg thereby increasing the size of the electrical wire receiving space.

In some embodiments, in the first position of the actuator, a force applied by the actuator on the extended leg decreases so that the spring clamp returns towards its initial configuration.

In some embodiments, the spring clamp further includes a plurality of segments including first and second segments, wherein the first segment is arranged and configured to contact the electrical terminal and the second segment is coupled to the first segment and the extended leg.

In some embodiments, the plurality of segments further comprises a third segment, wherein the second segment is coupled to the first segment via the third segment.

In some embodiments, the actuator is a lever, the lever being pivotable between the first and second positions.

In some embodiments, the electrical wire receiving space is arranged and configured to receive an electrical wire having one of a plurality different wire gauges selected from No. 8 AWG, No. 10 AWG, No. 12 AWG, and No. 14 AWG.

In some embodiments, the wiring device further includes a secondary mechanical spring arranged and configured to bias the actuator into the first position.

In some embodiments, the electrical terminal further comprises a plurality of electrical terminals and the wiring device is selected from one of a plug, wherein each terminal comprises a blade, or a connector, wherein each terminal comprises a contact.

Disclosed herein is a wiring device. In some embodiments, the wiring device includes a housing including a housing opening to receive an electrical wire coupled to line voltage, an electrical terminal disposed within the housing and substantially aligned with the housing opening, the electrical contact having a wire termination surface and an opposing mounting surface, and a wire terminal arranged and configured to mechanically and electrically secure the electrical wire to the wire termination surface.

In some embodiments, the wire terminal includes an actuator including a head portion, a cam and an axis of rotation, the actuator arranged at least partially within the housing and configured to be rotated by an instrument about the axis of rotation between a first position and a second position, wherein the head portion is configured to receive the user instrument, and a spring clamp having a mounting leg, a biasing leg and a clamping leg, the clamping leg including an opening formed therein, wherein a portion of the wire termination surface projects through the opening within the clamping leg, wherein the portion of the wire termination surface and the opening within the clamping leg together define an electrical wire receiving space, and wherein, in the second position, the cam applies a force perpendicular to the axis of rotation to the biasing leg towards the mounting surface to move the clamping leg in relation to the wire termination surface and enlarge the electrical wire receiving space to receive the electrical wire, and, in the first position, an edge of the opening formed within the clamping leg contacts the electrical wire to securely retain the electrical wire within the electrical wire receiving space and in contact with the electrical terminal.

In some embodiments, the wiring device is one of a plug, a connector, a pin, or a sleeve device.

In some embodiments, the housing includes a pocket arranged and configured to receive a portion of the electrical terminal and a portion of the wire terminal.

In some embodiments, the actuator is a quarter-turn cam.

In some embodiments, the instrument is a screwdriver.

In some embodiments, the head portion of the actuator is accessible via an opening formed in the housing.

In some embodiments, in the second position, the cam contacts the biasing leg of the spring clamp to move the clamping leg of the spring clamp relative to the electrical terminal to enlarge the electrical wire receiving space.

In some embodiments, in the first position, the cam reduces its contact force with the biasing leg of the spring clamp so that the clamping leg of the spring clamp returns towards an initial position to secure the electrical wire against the electrical terminal.

In some embodiments, the electrical wire is secured between the electrical terminal and an inner edge of the opening formed in the clamping leg of the spring clamp.

In some embodiments, the mounting leg of the spring clamp is coupled to the electrical terminal.

In some embodiments, the electrical terminal includes a tab and arranged and configured to be positioned within the opening.

In some embodiments, the spring clamp further includes a leg (e.g., an extended leg) extending from the clamping leg of the spring clamp, and wherein, in the second position, the cam contacts the extended leg to move the clamping leg of the spring clamp relative to the electrical terminal to enlarge the electrical wire receiving space.

In some embodiments, in the first position, the cam reduces it contact force with the extended leg so that the clamping leg of the spring clamp returns towards an initial position to secure the electrical wire against the electrical terminal.

### BRIEF DESCRIPTION OF THE DRAWINGS

By way of example, a specific embodiment of the disclosed device will now be described, with reference to the accompanying drawings, in which:

FIG. 1A illustrates a perspective view of an embodiment of a wiring device (e.g., plug and connector) in accordance with one or more features of the present disclosure, the wiring device including wire terminals in accordance with one or more features of the present disclosure;

FIG. 1B illustrates an exploded view of the wiring device of FIG. 1A;

FIG. 1C illustrates a side view of the wiring device of FIG. 1A, parts of the housing of the wiring device removed;

FIG. 1D illustrates a bottom view of the wiring device of FIG. 1A, parts of the housing of the wiring device removed;

FIG. 1E illustrates a perspective view of the wiring device of FIG. 1A, parts of the housing of the wiring device removed;

FIG. 1F illustrates a perspective view of the wiring device of FIG. 1A, parts of the electrical terminal and housing of the wiring device removed;

FIG. 1G illustrates a bottom perspective view of the wiring device of FIG. 1A, parts of the housing of the wiring device removed;

FIG. 1H illustrates a perspective view of the wire terminals positioned in the wiring device of FIG. 1A;

FIG. 1I illustrates a side view of the wire terminals of FIG. 1H;

FIG. 1J illustrates a bottom view of the wire terminals of FIG. 1H;

FIG. 1K illustrates an alternate side view of the wire terminals of FIG. 1H, the wire terminals illustrated in the second position;

FIG. 1L illustrates a perspective views of the wire terminal of FIG. 1H, the wire terminal illustrated in the first position;

FIG. 1M illustrates a perspective views of the wire terminal of FIG. 1H, the wire terminal illustrated in the second position;

FIG. 2A illustrates a perspective view of an alternate embodiment of a wire terminal in accordance with one or more features of the present disclosure, the wire terminal may be used in a wiring device such as, for example, the wiring device shown in FIG. 1A;

FIG. 2B illustrates a side view of the wire terminal of FIG. 2A, the wire terminal illustrated in the first position;

FIG. 2C illustrates a side view of the wire terminal of FIG. 2A, the wire terminal illustrated in the second position;

FIG. 2D illustrates various views of the wire terminal of FIG. 2A moving between the first and second positions;

FIG. 2E illustrates an alternate perspective view of the wire terminal of FIG. 2A;

FIG. 3 illustrates a perspective view of an example embodiment of a spring clamp in accordance with one or more features of the present disclosure;

FIG. 4A illustrates a perspective view of an example embodiment of a wiring device utilizing a wire terminal incorporating the spring clamp shown in FIG. 3 in accordance with one or more features of the present disclosure, the wire terminal and spring clamp illustrated in the first or closed position;

FIG. 4B illustrates a cross-sectional view of the wiring device shown in FIG. 4A, the wire terminal and spring clamp illustrated in the second or opened position;

FIG. 4C illustrates a detailed view of the wiring device shown in FIG. 4B, the wire terminal and spring clamp illustrated in the second or opened position;

FIG. 5A illustrates a perspective view of an example embodiment of a wiring device utilizing a wire terminal incorporating the spring clamp shown in FIG. 3 in accordance with one or more features of the present disclosure, the wire terminal and spring clamp illustrated in the first or closed position;

FIG. 5B illustrates a top view of the wire terminal shown in FIG. 5B, the wire terminal and spring clamp illustrated in the first or closed position;

FIG. 5C illustrates a perspective view of the wiring device shown in FIG. 5A, the wire terminal and spring clamp illustrated in the second or opened position;

FIG. 5D illustrates a top view of the wire terminal shown in FIG. 5C, the wire terminal and spring clamp illustrated in the second or opened position;

FIG. 5E illustrates a perspective view of an example embodiment of a lever used in connection with the wire terminal shown in FIGS. 5A-5D in accordance with one or more features of the present disclosure;

FIG. 6A illustrates a perspective view of an example embodiment of an alternate embodiment of a wire terminal incorporating the spring clamp shown in FIG. 3 in accordance with one or more features of the present disclosure, the wire terminal and spring clamp illustrated in the first or closed position;

FIG. 6B illustrates a top view of the wire terminal shown in FIG. 6B, the wire terminal and spring clamp illustrated in the first or closed position;

FIG. 6C illustrates a perspective view of the wire terminal shown in FIG. 6A, the wire terminal and spring clamp illustrated in the second or opened position;

FIG. 6D illustrates a top view of the wire terminal shown in FIG. 6C, the wire terminal and spring clamp illustrated in the second or opened position;

FIG. 6E illustrates a perspective view of an example embodiment of a secondary mechanical spring used in connection with the wire terminal shown in FIGS. 6A-6D in accordance with one or more features of the present disclosure;

FIG. 7A illustrates a front perspective view of an example embodiment of a wiring device (e.g., a locking plug) incorporating a wire terminal and the spring clamp shown in FIG. 3 in accordance with one or more features of the present disclosure, the wire terminal and spring clamp illustrated in the first or closed position;

FIG. 7B illustrates a rear perspective view of the wiring device (e.g., a locking plug) shown in FIG. 7A, the wire terminal and spring clamp illustrated in the first or closed position;

FIG. 7C illustrates an exploded perspective view of the wiring device (e.g., a locking plug) shown in FIG. 7A;

FIG. 7D illustrates a partial perspective view of the wiring device (e.g., a locking plug) shown in FIG. 7A, the wire terminal and spring clamp illustrated in the first or closed position;

FIG. 7E illustrates an alternate partial perspective view of the wiring device (e.g., a locking plug) shown in FIG. 7A, the wire terminal and spring clamp illustrated in the first or closed position;

FIG. 7F illustrates a rear view of the wiring device (e.g., a locking plug) shown in FIG. 7A, the wire terminal and spring clamp illustrated in the first or closed position;

FIG. 7G illustrates a rear view of the wiring device (e.g., a locking plug) shown in FIG. 7A, the wire terminal and spring clamp illustrated in the second or opened position; and

FIG. 8 illustrates an exploded perspective view of an example embodiment of a wiring device (e.g., a connector) incorporating a wire terminal and the spring clamp shown in FIG. 3 in accordance with one or more features of the present disclosure.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be further understood that this disclosure is not limited to the particular embodiments illustrated herein. In the drawings, like numbers refer to like elements throughout unless otherwise noted.

### DETAILED DESCRIPTION

Various features or the like of wire terminals or wire termination mechanisms (terms used interchangeably herein) and corresponding methods of use arranged and configured to enable an electrical wire to be installed and secured within a wiring device will now be described more fully hereinafter with reference to the accompanying drawings, in which one or more features of the wire terminals will be shown and described. It should be appreciated that the various features may be used independently of, or in combination, with each other. It will be appreciated that the various wire terminals as disclosed herein may be embodied in many different forms and should not be construed as being limited to the embodiments set forth herein. Rather, these embodiments are provided so that this disclosure will convey certain features of the wire terminals to those skilled in the art.

In accordance with one or more features of the present disclosure, various wire terminals arranged and configured to enable an installer to quickly and easily install, secure, engage, couple, etc. (terms used interchangeably herein without the intent to limit or distinguish) one or more electrical wires to an electrical wiring device will be shown and described. As will be described herein, various embodiments utilize a main spring, a spring clip, a spring clamp, a cage clamp, etc. (terms used interchangeably herein without the intent to limit or distinguish) and a rotatable actuator having a cam. In use, the rotatable actuator is engaged by an external instrument such as, for example, a screwdriver, to rotate the actuator. In some embodiments, the actuator rotates through a limited range of motion such as, for example, a quarter-turn (e.g., ninety-degrees of rotation) to manipulate the spring clamp between first and second positions. In use, the actuator with limited movement (e.g., quarter-turn rotation) manipulates the spring clamp to displace a certain distance to accept an electrical wire and to secure the electrical wire against the electrical terminal. That is, in use, an actuator and spring clamp is used to selectively couple the electrical wire to the wiring device (e.g., the wire terminals are arranged and configured to mechanically and electrically secure an electrical wire to an electrical terminal (e.g., a wire termination surface of an electrical terminal)).

As will be shown and described, in use, the present disclosure discloses several embodiments of wire terminals particularly configured for use in connection with plug and connector type devices, pin and sleeve type devices, wiring devices, etc. However, it should be appreciated that the various wire terminals may be incorporated into any suitable wiring device arranged and configured to receive line-voltage, either now known or hereafter developed such as, for example, an electrical receptacle, a switch, a dimmer, an occupancy sensor, a lighting fixture, a ground/arc fault circuit interrupter, fan speed controls, energy management devices, surge suppressors, and the like. As such, it should be understood that the term “wiring device” is intended to include any of the standard line voltage electrical devices that are now known or hereafter developed. Line voltage refers to a voltage, typically Alternating Current (AC), that is supplied to buildings/residences (e.g., electric light and power), for example, 110 VAC, 115 VAC, 120 VAC, 125 VAC, 208 VAC, 220 VAC, 230 VAC, 240 VAC, single or multiphase. Line voltage devices are distinguished from low voltage devices, which refer to devices that receive a voltage which is less than a certain threshold (50 Volts for example, AC or DC). This reduced voltage is typically used for communication, signaling, data/multimedia transmission, low voltage charging, and the like. As such, the present disclosure should not be limited to any particular line voltage wiring device unless explicitly claimed. While the present disclosure describes and shows the wire terminals in combination with plug and connector devices, the present disclosure should not be limited to plug and connectors and/or pin and sleeve. Thus, the present disclosure should not be limited to any particular device unless specifically claimed.

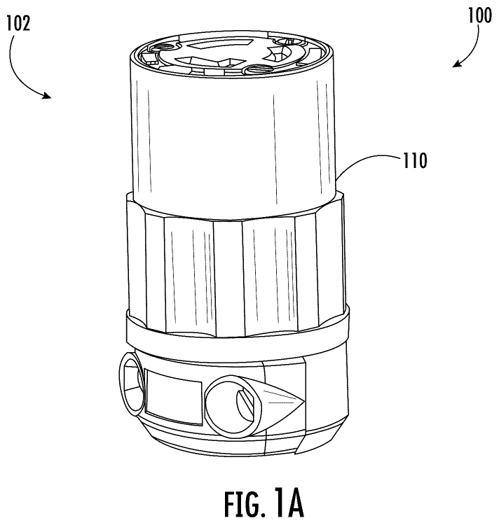

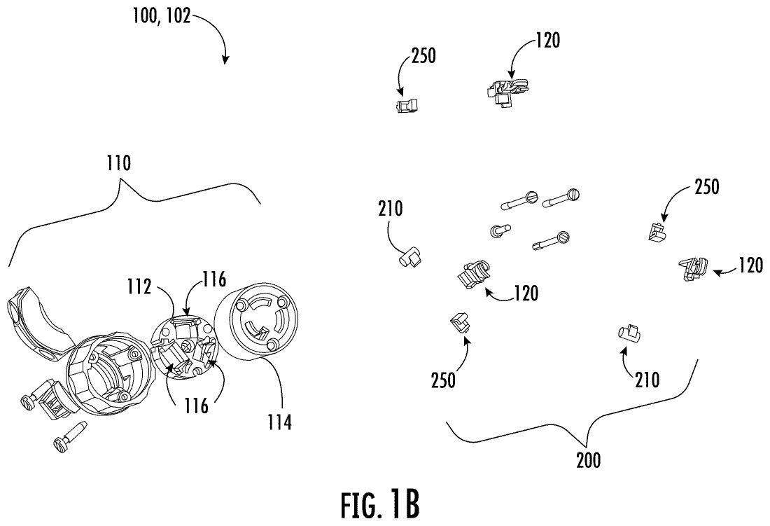

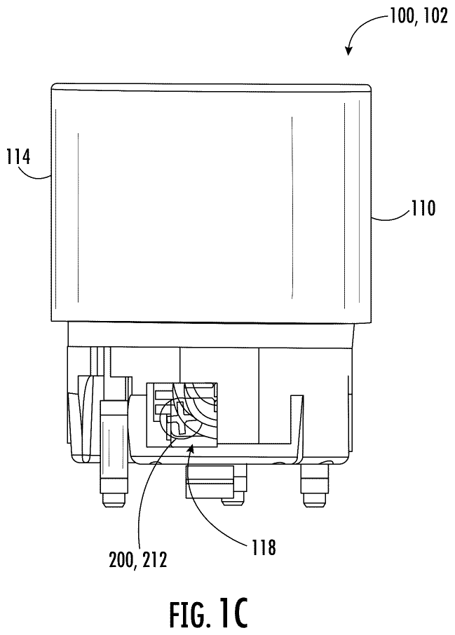

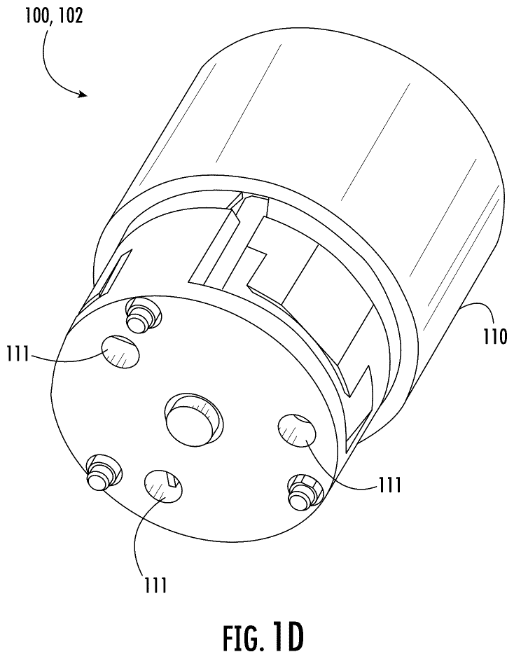

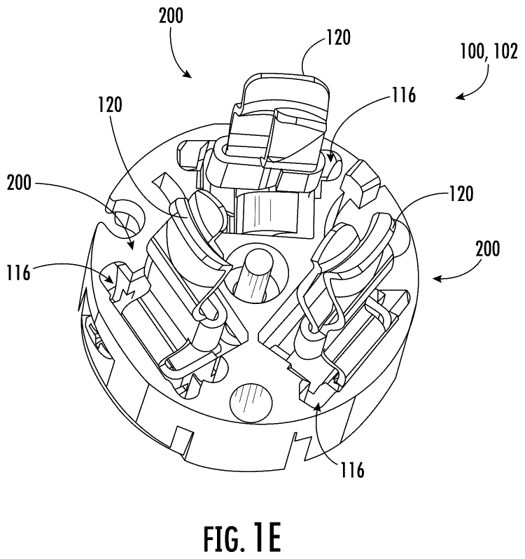

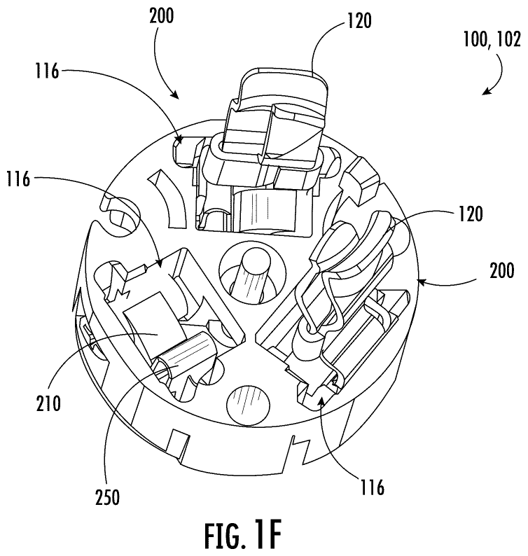

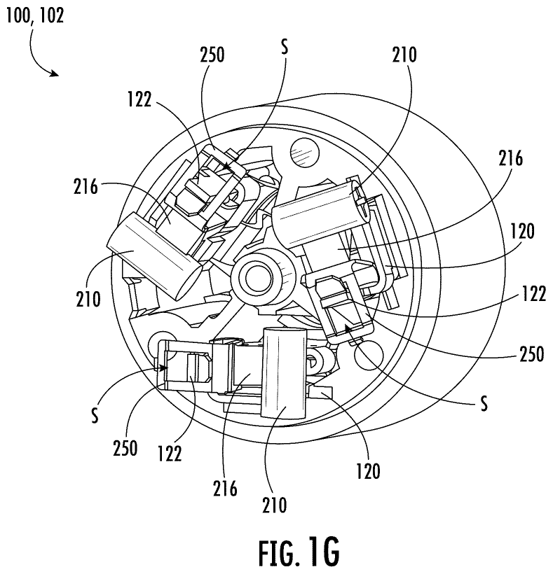

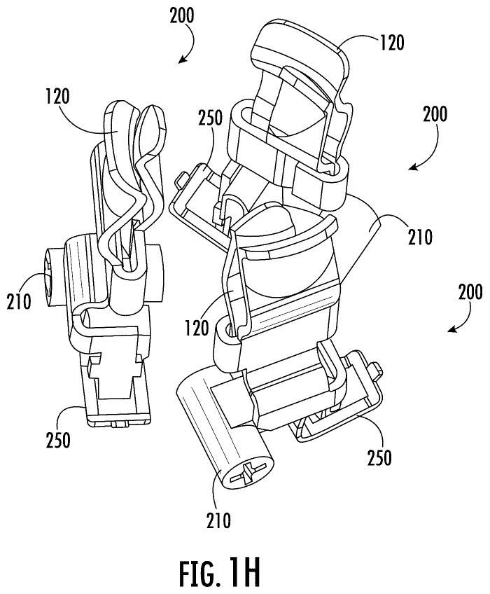

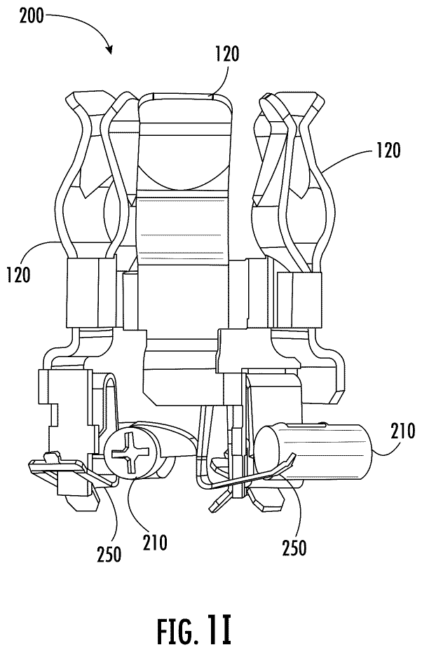

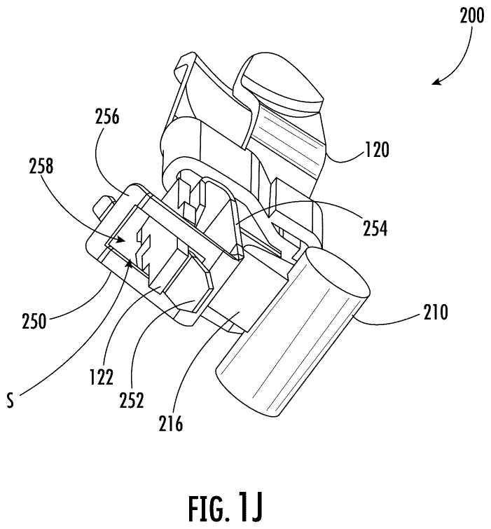

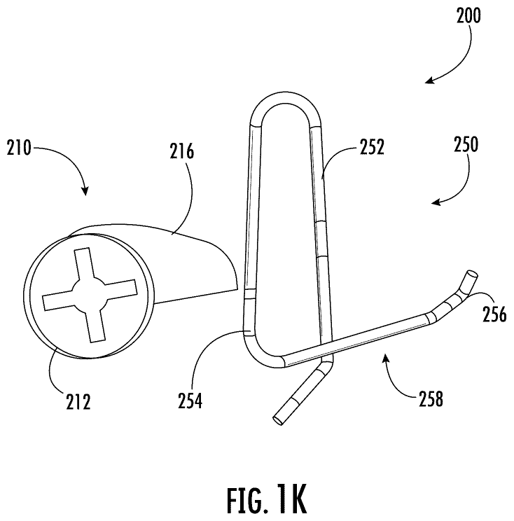

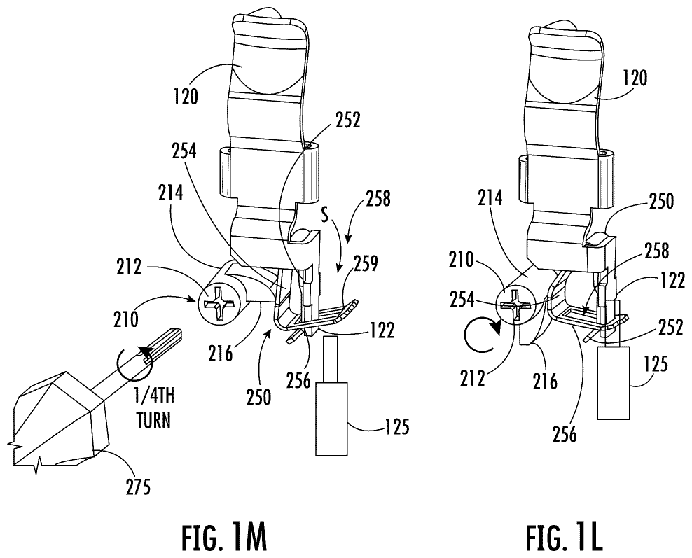

Referring to FIGS. 1A-1M, in accordance with one or more features of the present disclosure, example embodiments of a wiring device 100 is shown. As illustrated, the wiring device 100 is a connector 102 (other embodiments may be a plug or the like). The wiring device 100 includes a housing 110 including one or more openings 111 (FIG. 1D) formed in the housing 110 (referred to herein as a housing opening) to receive an electrical wire coupled to line voltage. For example, as illustrated, in some embodiments, the housing 110 may include three housing openings 111 formed in a rear surface thereof, one for each of the phase, neutral, and ground wires, although this is but one configuration and more or less openings may be included. The housing 110 may include a first component or wiring module 112 and a second component or husk 114 that, when assembled, enclose a variety of components, although the housing 110 may include less or more portions. In use, the housing 110 includes one or more electrical terminals 120 substantially aligned with the housing opening. As will be described in greater detail herein, the electrical terminal 120 includes a wire termination surface for contacting the electrical wire inserted into the housing via the housing opening and an opposing mounting surface. In addition, the housing 110 also includes one or more wire terminal assemblies 200. In use, the housing 110, the first component or wiring module 112, may include one or more pockets 116 arranged and configured to receive the electrical terminals 120, the wire terminal assemblies 200 including, for example, the actuator 210 and the spring clamp 250 (as will be described in greater detail below), and any other components. That is, for example, the housing 110 may include a plurality of pockets 116, which in some embodiment may be formed in the first component or wiring module 112. In use, the pockets 116 are arranged and configured to receive, seat, etc. the wire terminal assemblies 200 including the actuator 210 and the spring clamp 250, the electrical terminals 120, etc. In use, the pockets 116 receiving the actuator 210 are arranged and configured to enable rotation of the actuator 210 for reasons described below. In some embodiments, for reasons that will become apparent below, the first component or wiring module 112 and the second component or husk 114 are arranged and configured to prevent over rotation of the actuator 210 (e.g., to prevent actuator rotation beyond the intended ninety-degrees of rotation for a quarter-turn cam). In some embodiments, the first component or wiring module 112 and the second component or husk 114 may include one or more stops to prevent the actuator 210 from rotating too far in one direction, the spring clamp 250 may include, or be associated with, a stop to prevent the actuator 210 from rotating too far in the opposite direction.

An example embodiment of a wire terminal assembly or wire terminal 200 (terms used interchangeably herein without the intent to limit or distinguish) in accordance with one or more features of the present disclosure will now be described. As will be appreciated by one of ordinary skill in the art, the wire terminal assembly 200 is arranged and configured to be incorporated into the wiring device 100 such as, for example, the connector 102. However, it should be understood that the wire terminal may be incorporated into any wiring device now know or hereafter developed. As such, the present disclosure should not be limited to any particular wiring device.

As illustrated, generally speaking, the wiring device 100 may include three electrical terminals 120 (e.g., phase, neutral, and ground) and three corresponding wire terminals 200, although this is but one configuration and, different numbers of contacts and wire terminals may be used depending on the wiring device (e.g., when the wiring device is a pin or sleeve device).

As illustrated, in some embodiments, the wire terminal 200 includes an actuator 210 and a spring clamp 250 (e.g., wire terminal assembly includes the actuator 210, the spring clamp 250, and the electrical terminal 120 (e.g., blade/pin or female contact)). In use, the actuator 210 is rotatably positioned within the housing 110 of the wiring device 100. In addition, as will be described in greater detail herein, in use, the actuator 210 is arranged and configured to be engaged by an instrument 275 such as, for example, a screwdriver (FIG. 1M). In addition, the actuator 210 includes a cam, a projection, a ledge, etc. 216 (terms used interchangeable herein without the intent to limit or distinguish) arranged and configured to contact, interact with, the spring clamp 250 so that, in use, rotation of the actuator 210 manipulates (e.g., moves, etc.) the spring clamp 250 between first and second positions.

That is, in some embodiments, the actuator 210 may include a head portion 212 arranged and configured to be engaged by the instrument 275, a body portion 214, and a cam 216 extending from the body portion 214. The actuator 210 including an axis of rotation. In use, the actuator 210 is arranged at least partially within the housing 110 and is configured to be rotated by an instrument about the axis of rotation between the first position and the second position, wherein the head portion 212 is configured to receive the user instrument. The head portion 212 may be in any suitable form such as flat head (e.g., slotted/straight), Philips, cross, square, Robertson, hex, star, hexalobular, pentolobe, clutch, pentagon, 12-point, one-way, spanner, tri-angle, tri-point, tri-wing, or a combination thereof. The geometry of the head portion 212 may facilitate proper operation and prevent damage from over-torquing. For example, a cross drive head may cause the instrument 275 to cam-out if a torque above a predetermined amount is applied, preventing damage. In use, as best illustrated in FIG. 1C, the head portion 212 of the actuator 210 is accessible through an opening 118 formed in the housing 110 of the wiring device 100.

In use, the actuator 210 is moveable (i.e., rotatable) between a first (e.g., closed) position (illustratively shown in FIG. 1L) and a second (e.g., opened) position (illustratively shown in FIGS. 1K and 1M). In some embodiments, as illustrated, the actuator 210 is rotated via an instrument 275. In other embodiments, the actuator 210 may be rotated directly by hand without the need to use an instrument 275. In an embodiment, the actuator 210 is arranged and configured as a quarter-turn cam. That is, the actuator 210 is arranged and configured so that rotation of the actuator 210 via the instrument by a quarter-turn, or approximately ninety-degrees, rotates the actuator 210 between the first and second positions, although other configurations are envisioned such as, four-five degrees, one-hundred and eighty degrees, or the like. During installation, with the actuator 210 in the second position (e.g., with the cam 216 in contact with the spring clamp 250), a user may insert an electrical wire 125 into an electrical wire receiving space S. Thereafter, once the electrical wire 125 has been inserted, the user may rotate the actuator 210 to the first position to retain the wire 125 within the wire terminal 200 and in contact with the electrical terminal 120 (e.g., with the wire termination surface of the electrical terminal 120).

Thus arranged, with the actuator 210 in the second position, the cam 216 contacts the spring clamp 250 (e.g., the second leg 254 of the spring clamp 250 as will be described in greater detail below below) to manipulate (e.g., move) the spring clamp 250, or a portion thereof, relative to the electrical terminal 120 to enlarge or increase the size of the electrical wire receiving space S so that the user can insert the electrical wire 125 into the electrical wire receiving space S and the opening 258 formed in the spring clamp 250. Thereafter, with the electrical wire 125 inserted into the electrical wire receiving space S and within the opening 258 formed in the spring clamp 250, the user rotates the actuator 210 via the instrument 275 to the first position so that the spring clamp 250 returns towards its initial or relaxed position. That is, in the first position, the cam 216 is rotated away from the spring clamp 250 so that the cam 216 no longer contacts, or reduces its contact, with the spring clamp 250 so that the spring clamp 250 is in a relaxed state whereby the spring clamp 250 applies a supplemental force to retain the wire 125 within the electrical wire receiving space S, within the opening 258 formed in the spring clamp 250, and to ensure that the wire 125 remains in contact with the electrical terminal 120 of the wiring device 100.

Thus arranged, in use, the actuator 210 may be moved from the first position to the second position, or may be provided in the second position. In either event, with the actuator 210 in the second position, the cam 216 contacts and manipulates the spring clamp 250 to create or enlarge the electrical wire receiving space S to enable a user to insert the electrical wire 125 into the wire terminal 200 (e.g., in the second position, the electrical wire receiving space S may be enlarged a sufficient amount so that the electrical wire 125 can be freely inserted into the electrical wire receiving space S without interference or resistance). In some embodiments, as will be described in greater detail below, the spring clamp 250, or at least a portion thereof, may be moved away from the electrical terminal 120 thereby creating or enlarging the electrical wire receiving space S for the electrical wire 125 to be inserted when the actuator 210 is in the second position.

Once the wire 125 is installed into the electrical wire receiving space S, the actuator 210 may be rotated via the instrument 275 to the first position. In the first position, the spring clamp 250 is arranged and configured to apply a supplemental force to retain the wire 125 within the electrical wire receiving space S and to ensure that the wire 125 remains in contact with the electrical terminal 120 of the wiring device 100. That is, in the first position, the spring clamp 250 is arranged and configured to provide an increased retention force to maintain the electrical wire 125 within the electrical wire receiving space S (e.g., the spring clamp 250 is arranged and configured to press against the installed electrical wire 125 sandwiching, or compressing, the wire 125 between a leg of the spring clamp 250 and the electrical terminal 120.

As best illustrated in FIG. 1K, in some embodiments, the spring clamp 250 may include a first or mounting leg 252, a second or biasing leg 254 having a first end and a second end, the first end coupled to an end of the first or mounting leg 252, and a third or clamping leg 256 coupled to the second end of the second or biasing leg 254. Terms first or mounting used interchangeably herein; second or biasing used interchangeably herein; and third or clamping used interchangeably herein. In this fashion, first, second, and third legs 252, 254, 256 together form a loop in the spring clamp 250. The loop may be either a closed (e.g., complete loop) or a partial (e.g., an open loop). As illustrated, in some embodiments, the spring clamp 250 may be monolithically formed. Alternatively, however, the spring clamp 250 may be manufactured from multiple legs, which may be assembled together. In use, as previously mentioned, the spring clamp 250 may be driven by the movement of the cam 216 on the actuator 210.

As illustrated, the third leg 256 of the spring clamp 250 includes an opening 258 (best illustrated in FIGS. 1L and 1M) arranged and configured to receive a portion of the electrical wire 125 and a portion, a segment, a leg, etc. 122 (terms used interchangeable herein without the intent to limit or distinguish) of the electrical terminal 120 (e.g., also referred to herein as the wire termination surface). A portion of the first leg 252 of the spring clamp 250 may also extend through the opening 258 formed in the third leg 256 of the spring clamp 250. Thus arranged, a portion of the wire termination surface of the electrical terminal 120 projects through the opening 258 formed within the third leg 256. The portion of the wire termination surface and the opening 258 within the third leg 256 together defining the electrical wire receiving space S.

As illustrated, with the actuator 210 in the second position, the cam 216 of the actuator 210 contacts the second leg 254 of the spring clamp 250 manipulating, pushing, moving, etc. (terms used interchangeably herein without the intent to limit or distinguish) the third leg 256 of the spring clamp 250 relative to the electrical terminal 120 and the first leg 252 of the spring clamp 250 thereby increasing the size of the electrical wire receiving space S to facilitate insertion of the electrical wire 125 therein. That is, with the actuator 210 in the second position, the cam 216 applies a force perpendicular to the axis of rotation to the second or biasing leg 254 towards the mounting surface of the electrical terminal 120 to move the third or clamping leg 256 in relation to the wire termination surface and enlarging the electrical wire receiving space S to receive the electrical wire 125. Meanwhile, with the actuator 210 in the first position, an edge or surface 259 of the opening 258 formed within the third or clamping leg 256 contacts the electrical wire 125 to securely retain the electrical wire 125 within the electrical wire receiving space S and in contact with the electrical terminal 120.

Once inserted, rotation of the actuator 210 via the instrument 275 to the first position, removes, or at least reduces, the force applied by the cam 216 resulting in the spring clamp 250 returning towards its relaxed or natural configuration, which causes the electrical wire 125 to be compressed between the inner edge or surface 259 of the opening 258 formed in the third leg 256 of the spring clamp 250 and the leg 122 of the electrical terminal 120. Thus arranged, the spring clamp 250 assists with providing increased retention force to maintain the electrical wire 125 within the electrical wire receiving space S (e.g., in the first position, with the electrical wire 125 positioned within the electrical wire receiving space S, the spring clamp 250 pushes against the electrical wire 125 to provide increased retention force on the wire 125 against the electrical terminal 120).

In addition, in some embodiments, the inner edge or surface 259 of the opening 258 in the third leg 256 of the spring clamp 250 may be sharpened (e.g., contain a sharpened edge portion) so that the inner edge or surface 259 may be arranged and configured to “cut” (e.g., engage or bite) into the electrical wire 125 to ensure contact is retained (e.g., to provide additional retention force in maintaining the wire 125 in the electrical wire receiving space S in the first position). However, this is but one configuration and other configurations are envisioned. For example, the inner edge or surface 259 may have any suitable shape such as a flat surface parallel to the wire axis, a “V” shape, a curved surface (either concave or convex with respect to the wire axis), etc. In use, the edge or surface 259 may be configured to “bite” into the electrical wire 125.

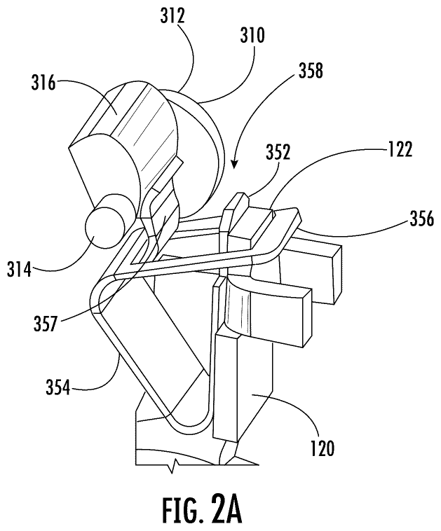

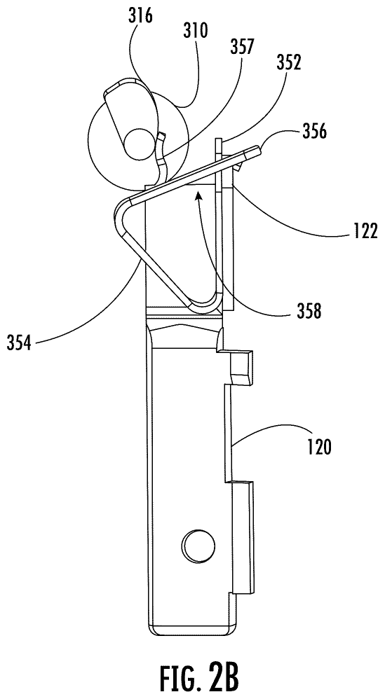

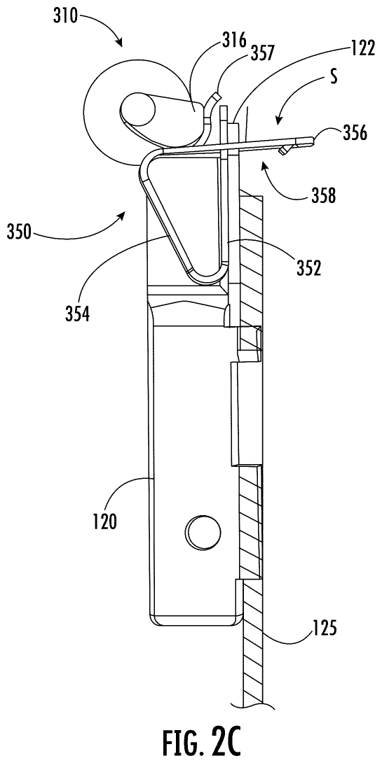

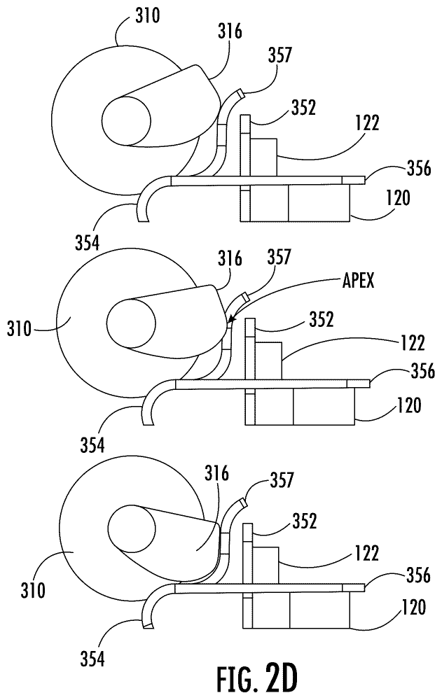

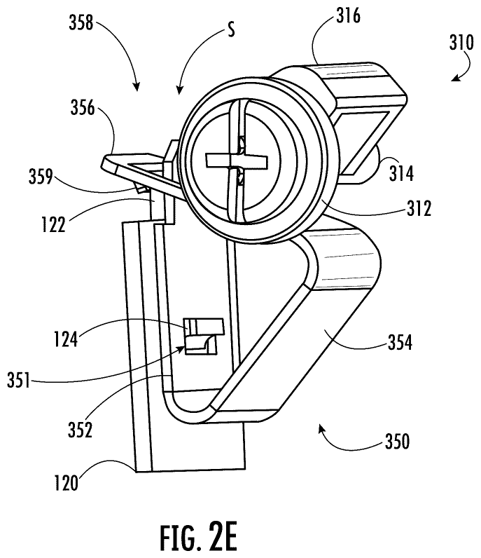

The spring clamp 250, and more particularly, the first leg 252 of the spring clamp 250, may be positioned in contact with the electrical terminal 120. In some embodiments, the first leg 252 of the spring clamp 250 may be coupled to the electrical terminal 120. The spring clamp 250 may be coupled to the electrical terminal 120 by any suitable mechanism now known or hereafter developed. For example, in some embodiments, as illustrated in FIG. 2E, the electrical terminal 120 may include a tab, a ledge, a projection, or the like 124 (terms used interchangeably herein without the intent to limit or distinguish) extending therefrom. The spring clamp 250, and more particularly, the first leg 252 of the spring clamp 250, may include an opening for receiving the tab 124.

Thus arranged, in some embodiments, the spring clamp 250 may be press-fitted to the electrical terminal 120. However, this is but one configuration and other configurations are envisioned. For example, the spring clamp 250 may be welded or crimped to the electrical terminal 120.

In addition, and/or alternatively, the housing 110 may be arranged and configured to contact the spring clamp 250 such as, a top portion of the spring clamp 250, to secure the spring clamp 250 in position. Moreover, the housing 110 may include additional tabs arranged and configured to interact with the spring clamp 250 to reduce or limit lateral movement of the spring clamp 250.

In use, the electrical wire receiving space S (e.g., opening defined by the inner edge or surface 259 of the opening 258 formed in the third leg 256 of the spring clamp 250 and the leg 122 of the electrical terminal 120) may be arranged and configured to receive a plurality different wire gauges and types. In use, the wire gauges may be any now known or hereafter developed wire gauges including, for example, the electrical wire receiving space S may be arranged and configured to receive No. 8 American Wire Gauge (AWG), No. 10 AWG, No. 12 AWG, No. 14 AWG, etc. In addition, the electrical wire receiving space S may be arranged and configured to receive stranded wire, solid wire, tinned wire, etc.

In accordance with one or more features of the present disclosure, an improved wire terminal utilizing a quick-turn actuator such as, for example, a quarter-turn screw, is provided. As such, users are provided with a quick connect solution, which may incorporate a quarter-turn screw to quickly and easily enable secure installation and/or removal of an electrical wire. For example, in some embodiments, by incorporating an actuator with a rotational cam motion to actuate the spring clamp, a quarter-turn is needed to enable insertion of the electrical wire, while an opposite, quarter-turn is needed to secure the electrical wire within the wiring device. Thus, a quarter-turn solution is provided for coupling and decoupling electrical wires to a wiring device such as a plug and connector device or a pin and sleeve device in the field. Moreover, by utilizing a mechanism that is actuated by an instrument 275 (e.g., a screwdriver) with relatively shorter rotational movement (e.g., quarter-turn), the wire terminal significantly reduces the amount of time needed by an end user tasked with multiple assemblies.

Referring to FIGS. 2A-2E, an alternate example embodiment of a wire terminal 300 in accordance with one or more features of the present disclosure will be described. As will be appreciated by one of ordinary skill in the art, the wire terminal 300 may be incorporated into any wiring device such as, for example, wiring device 100.

As will be described herein, the wire terminal 300 is substantially similar to the wire terminal 200 previously described thus for the sake of brevity some description is omitted herefrom. As illustrated, in use, the primary difference between the wire terminal 300 and the wire terminal 200 is the orientation of the spring clamp and the relative positioning of the actuator. As will be described in greater detail herein, by moving the position of the actuator relative to the spring clamp, space savings is provided, which is particularly useful when utilized in pin and sleeve type devices, which may incorporate four, five, or more electrical contacts and corresponding wire terminals.

As illustrated, in some embodiments, the wire terminal 300 includes an actuator 310 and a spring clamp 350. In use, the actuator 310 is rotatably positioned within the housing of a wiring device such as, for example, housing 110 of wiring device 100. In addition, in use, the actuator 310 is arranged and configured to be engaged by an instrument such as, for example, instrument 275, which may be provided in the form of a screwdriver. In addition, the actuator 310 includes a cam 316 arranged and configured to contact, interact with, etc. the spring clamp 350 so that, in use, rotation of the actuator 310 manipulates (e.g., moves, etc.) the spring clamp 350 between first and second positions.

That is, in some embodiments, the actuator 310 may include a head portion 312 arranged and configured to be engaged by the instrument 275, a body portion 314 substantially positioned within the housing of the wiring device, and a cam 316 coupled to, extending from, etc. the body portion 314. In use, as previously described in connection with wire terminal 200, the head portion 312 of the actuator 310 is accessible through an opening formed in the housing of the wiring device.

In use, the actuator 310 is moveable (i.e., rotatable) between a first (e.g., closed) position (illustratively shown in FIGS. 2A, 2B, 2D (partially), and 2E) and a second (e.g., opened) position (illustratively shown in FIGS. 2C and 2D (partially)). In some embodiments, the actuator 310 is rotated via an instrument. In an embodiment, the actuator 310 is arranged and configured as a quarter-turn cam. That is, the actuator 310 is arranged and configured so that rotation of the actuator 310 via the instrument 275 by a quarter-turn, or approximately ninety-degrees, rotates the actuator 310 between the first and second positions, although other configurations are envisioned such as, four-five degrees, one-hundred and eighty degrees, or the like. During installation, with the actuator 310 in the second position (e.g., with the cam 316 in contact with the spring clamp 350), a user may insert an electrical wire 125 into an electrical wire receiving space S. Thereafter, once the electrical wire 125 has been inserted, the user may rotate the actuator 310 to the first position to retain the wire 125 within the wire terminal 300 and in contact with the electrical terminal 120.

Thus arranged, with the actuator 310 in the second position, the cam 316 contacts the spring clamp 350 (e.g., a leg, an extended leg, or projection 357 of the spring clamp 350 extending from the third leg 356 of the spring clamp 350 as will be described in greater detail below below) to manipulate (e.g., move) the spring clamp 350, or a portion thereof, relative to the electrical terminal 120 to enlarge or increase the size of the electrical wire receiving space S so that the user can insert the electrical wire 125 into the electrical wire receiving space S and the opening 358 formed in the spring clamp 350. Thereafter, with the electrical wire 125 inserted into the electrical wire receiving space S and within the opening 358 formed in the spring clamp 350, the user rotates the actuator 310 via the instrument to the first position so that the spring clamp 350 returns towards its initial or relaxed position. That is, in the first position, the cam 316 is rotated away from the spring clamp 350 so that the cam 316 no longer contacts, or reduces its contact or its contact force, with the spring clamp 350 so that the spring clamp 350 is in a relaxed state whereby the spring clamp 350 applies a supplemental force to retain the wire 125 within the electrical wire receiving space S, within the opening 358 formed in the spring clamp 350, and to ensure that the wire 125 remains in contact with the electrical terminal 120 of the wiring device.

Thus arranged, in use, the actuator 310 may be moved from the first position to the second position, or may be provided in the second position. In either event, with the actuator 310 in the second position, the cam 316 contacts and manipulates the spring clamp 350 to create or enlarge the electrical wire receiving space S to enable a user to insert the electrical wire 125 into the wire terminal 300 (e.g., in the second position, the electrical wire receiving space S may be enlarged a sufficient amount so that the electrical wire 125 can be freely inserted into the electrical wire receiving space S without interference or resistance). In some embodiments, as will be described in greater detail below, the spring clamp 350, or at least a portion thereof, may be moved away from the electrical terminal 120 thereby creating or enlarging the electrical wire receiving space S for the electrical wire 125 to be inserted when the actuator 310 is in the second position.

Once the wire 125 is installed into the electrical wire receiving space S, the actuator 310 may be rotated via the instrument to the first position. In the first position, the spring clamp 350 is arranged and configured to apply a supplemental force to retain the wire 125 within the electrical wire receiving space S and to ensure that the wire 125 remains in contact with the electrical terminal 120 of the wiring device. That is, in the first position, the spring clamp 350 is arranged and configured to provide an increased retention force to maintain the electrical wire 125 within the electrical wire receiving space S (e.g., the spring clamp 350 is arranged and configured to press against the installed electrical wire 125 sandwiching, or compressing, the wire 125 between a portion of the spring clamp 350 and the electrical terminal 120.

As illustrated, in some embodiments, the spring clamp 350 may include a first or mounting leg 352, a second or biasing leg 354 having a first end and a second end, the first end coupled to an end of the first or mounting leg 352, and a third or clamping leg 356 coupled to the second end of the second or biasing leg 354. Terms first or mounting used interchangeably herein; second or biasing used interchangeably herein; and third or clamping used interchangeably herein. In this fashion, first, second, and third legs 352, 354, 356 together form a loop in the spring clamp 350. The loop may be either a closed (e.g., complete loop) or a partial (e.g., an open loop). In addition, as illustrated, the spring clamp 350 includes a leg or projection (e.g., an extended leg) 357 extending from (e.g., upwards) the third leg 356 of the spring clamp 350. As illustrated, in some embodiments, the spring clamp 350 may be monolithically formed. Alternatively, however, the spring clamp 350 may be manufactured from multiple legs, which may be assembled together. In use, as previously mentioned, the spring clamp 350 may be driven by the movement of the cam 316 on the actuator 310.

As illustrated, the third leg 356 of the spring clamp 350 includes an opening 358 arranged and configured to receive a portion of the electrical wire 125 and a leg 122 of the electrical terminal 120. A portion of the first leg 352 of the spring clamp 350 may extend through the opening 358 formed in the third leg 356 of the spring clamp 350. Thus arranged, as illustrated, with the actuator 310 in the second position, the cam 316 of the actuator 310 contacts the leg, extended leg, or projection 357 extending from (e.g., upwardly from) the third leg 356 of the spring clamp 350 manipulating the third leg 356 of the spring clamp 350 relative to the leg 122 of the electrical terminal 120 and the first leg 352 of the spring clamp 350 thereby increasing the size of the electrical wire receiving space S to facilitate insertion of the electrical wire 125 therein. Once inserted, rotation of the actuator 310 via the instrument to the first position, removes, or at least reduces, the force applied by the cam 316 resulting in the spring clamp 350 returning towards its relaxed or natural configuration, which causes the electrical wire 125 to be compressed between the inner edge or surface 359 of the opening 358 formed in the third leg 356 of the spring clamp 350 and the leg 122 (e.g., wire termination surface) of the electrical terminal 120. Thus arranged, the spring clamp 350 assists with providing increased retention force to maintain the electrical wire 125 within the electrical wire receiving space S (e.g., in the first position, with the electrical wire 125 positioned within the electrical wire receiving space S, the spring clamp 350 pushes against the electrical wire 125 to provide increased retention force on the wire 125 against the electrical terminal 120).

A best illustrated in FIG. 2E, the spring clamp 350, and more particularly, the first leg 352 of the spring clamp 350, may be positioned in contact with the electrical terminal 120. In some embodiments, the first leg 352 of the spring clamp 350 may be coupled to the electrical terminal 120. The spring clamp 350 may be coupled to the electrical terminal 120 by any suitable mechanism now known or hereafter developed. For example, in some embodiments, the electrical terminal 120 may include a tab 124 extending therefrom. The spring clamp 350, and more particularly, the first leg 352 of the spring clamp 350, may include an opening 351 for receiving the tab 124 (e.g., the spring clamp 350 may be positioned on the electrical terminal 120. The electrical terminal 120 including a tab 124, which the spring clamp 350 may rest on. Thus arranged, the spring clamp 350 is prevented from moving or sliding too far down the electrical terminal 120). In addition, extruding from the housing of the wiring device may be used to contact the top of the spring clamp during assembly further securing the position of the spring clamp 350 within the housing. Moreover, additional tabs from the terminal may be utilized to limit any lateral movement of the spring clamp 350.

In use, the electrical wire receiving space S (e.g., opening defined by the inner edge 359 of the opening 358 formed in the third leg 356 of the spring clamp 350 and the leg 122 of the electrical terminal 120) may be arranged and configured to receive a plurality different wire gauges and types. For example, the electrical wire receiving space S may be arranged and configured to receive 8-gauge, 10-gauge, 12-gauge, 14-gauge, etc. In addition, the electrical wire receiving space S may be arranged and configured to receive stranded wire, solid wire, etc.

In accordance with one or more features of the present disclosure, by providing specific cam profiles or curvatures, additional resistance against movement between the first and second profiles can be provided. For example, as best illustrated in FIG. 2D, by positioning the apex of the cam profile below the central axis of rotation, additional resistance against movement of the actuator is provided. In some embodiments, the cam may be configured with an over-center or detent action so that in an intermediate position, the cam would tend to snap over to the first or second position. Thus arranged, in use, the actuator provides a bi-stable quarter-turn fastener which “snaps” into each stable position. That is, in use, the interacting surface of the cam is arranged and configured to be biased towards the first or second position.

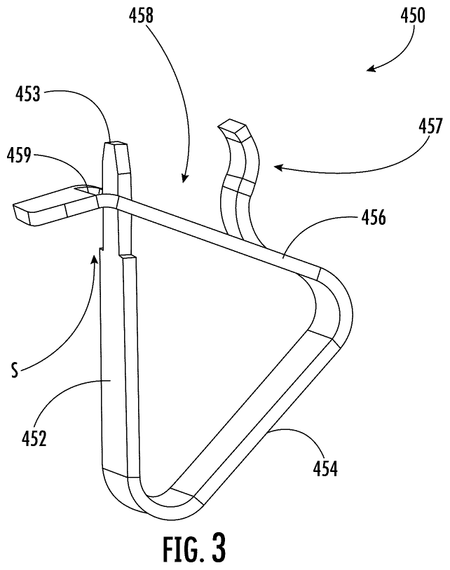

Referring to FIG. 3, an alternate example embodiment of a spring clamp 450 in accordance with one or more features of the present disclosure will be described. As will be appreciated by one of ordinary skill in the art, the spring clamp 450 may be incorporated into any wiring device such as, for example, wiring device 100, wiring device 400, wiring device 500, wiring device 700, wiring device 800, or the like, as will be described in greater detail below. As will be described herein, the spring clamp 450 is substantially similar to the spring clamp 350 previously described thus for the sake of brevity some description may be omitted herefrom.

As illustrated, in some embodiments, the spring clamp 450 may include a first or mounting leg 452, a second or biasing leg 454 having a first end and a second end, the first end coupled to an end of the first or mounting leg 452, and a third or clamping leg 456 coupled to the second end of the second or biasing leg 454. Terms first or mounting used interchangeably herein; second or biasing used interchangeably herein; and third or clamping used interchangeably herein. In this fashion, first, second, and third legs 452, 454, 456 together form a loop in the spring clamp 450. The loop may be either a closed (e.g., complete loop) or a partial (e.g., an open loop). In addition, as illustrated, the spring clamp 450 includes a leg, an extended leg, or projection 457 extending from, away, etc. (e.g., upwards or downwards depending on the orientation of the spring within the housing) the third leg 456 of the spring clamp 450.

As illustrated, in some embodiments, the spring clamp 450 may be monolithically formed. Alternatively, however, the spring clamp 450 may be manufactured from multiple legs, which may be assembled together.

As illustrated, the third leg 456 of the spring clamp 450 includes an opening 458 arranged and configured to receive a portion of the electrical wire such as, for example, electrical wire 125, and a portion, a segment, or a leg of the electrical terminal such as, for example, portion, segment, or leg 122 of the electrical terminal 120. In addition, a segment or portion 453 of the first leg 452 of the spring clamp 450 may extend through the opening 458 formed in the third leg 456 of the spring clamp 450. The opening 458 defining an inner edge or surface 459.

Thus arranged, in use, as previously described and as will be described in greater detail below, the extended leg 457 is arranged and configured to interact with an actuator (e.g., a rotary actuator, a lever, etc.) to enable the spring clamp 450 to transition between a first or closed position and a second or opened position to enlarge the electrical wire receiving space S so that the user can insert the electrical wire 125 into the electrical wire receiving space S and the opening 458 formed in the spring clamp 450.

In accordance with one or more features of the present disclosure, by incorporating the extended leg 457 and by configuring the actuator to interact with the extended leg 457 of the spring clamp 450 as opposed to the tail or biasing leg of the spring clamp, the wire terminal utilizes less space within the wiring device. In addition, and/or alternatively, the incorporation of the extended leg 457 increases the activation point from the bending point and thus reduces the amount of force or torque required to activate the spring clamp 450 (e.g., distance between the point of contact between the actuator and the extended leg and the bending point between the junction of the first leg 452 and the second leg 454).

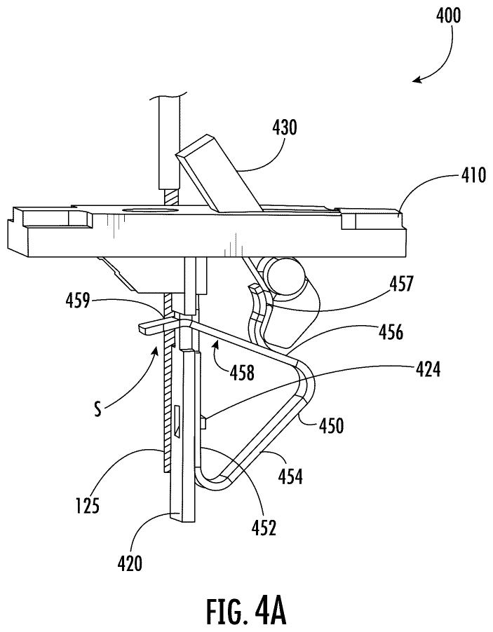

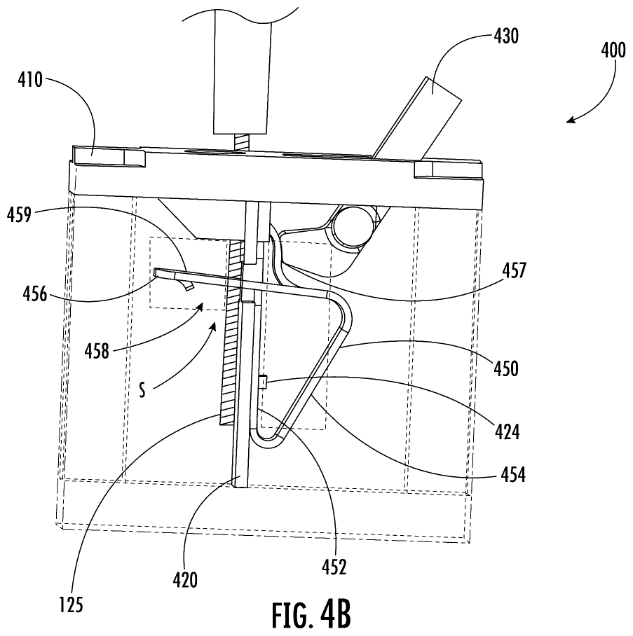

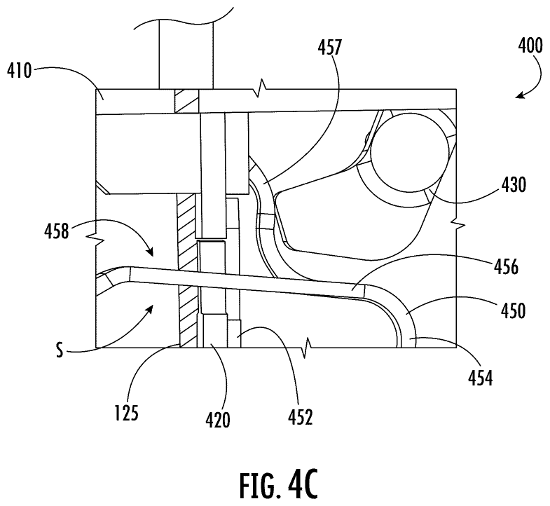

For example, with reference to FIGS. 4A-4C, an example embodiment of the spring clamp 450 in a wiring device 400 is illustrated. In use, as illustrated, by incorporating the extended leg 457 into the spring clamp 450, the actuator 430 may be positioned above the spring clamp 450 thereby saving space within the wiring device 400. Incorporation of the extended leg 457 allows the actuator (e.g., lever) 430 to be positioned above the spring clamp 450, which provides a slimmer profile for the spring clamp/actuator subassembly, which is particular useful when used in a wiring device in the form of a plug or a connector.

As illustrated, the wiring device 400 includes a housing 410 such as, for example, housing 110 of wiring device 100, or body portion (e.g., rear body portion or husk 712) of wiring device 700, or body portion (e.g., rear body portion or husk 812) of wiring device 800, or the like. In addition, the wiring device includes an electrical terminal 420 such as, for example, electrical terminal 120 positioned within housing 110, or electrical terminals or blades 716 positioned within wiring device 700, or electrical terminals or contacts 816 positioned within wiring device 800, or the like. Furthermore, the wiring device 400 includes a wire terminal including an actuator 430 extending through an opening formed in the housing 410 and a spring clamp 450 positioned within the housing 410. In use, the actuator 430 is positioned above the spring clamp 450. In use, the actuator 430 is moveable (e.g., pivotable) between a first or closed positioned (FIG. 4A) and a second or opened position (FIGS. 4B and 4C). For example, the actuator 430 may be pivotable between first and second positions, although this is but one configuration and other configurations are envisioned.

As previously mentioned, in the second or opened positioned, the actuator 430 contacts the extended leg 457 extending from the third leg 456 of the spring clamp 450 manipulating the third leg 456 of the spring clamp 450 relative to the first leg 452 of the spring clamp 450 and relative to the electrical terminal 420 thereby increasing the size of the electrical wire receiving space S to facilitate insertion of an electrical wire 125 therein. Once inserted, movement of the actuator 430 such as, pivotable movement of the actuator 430, to the first position, removes, or at least reduces, the force applied by the actuator 430 on the extended leg 457 of the spring clamp 450 allowing the spring clamp 450 to return towards the first or closed position (e.g., its initial, relaxed, or natural configuration), which causes the electrical wire 125 to be compressed between the inner edge or surface 459 of the opening 458 formed in the third leg 456 of the spring clamp 450 and the wire termination or contacting surface of the electrical terminal 420. Thus arranged, the spring clamp 450 assists with providing increased retention force to maintain the electrical wire 125 within the electrical wire receiving space S (e.g., in the first or closed position, with the electrical wire 125 positioned within the electrical wire receiving space S, the spring clamp 450 compresses against the electrical wire 125 to provide increased retention force on the wire 125 against the electrical terminal 420).

That is, as illustrated, the spring clamp 450, and more particularly, the first leg 452 of the spring clamp 450, may be positioned in contact with the electrical terminal 420. In some embodiments, the first leg 452 of the spring clamp 450 may be coupled to the electrical terminal 420. The spring clamp 450 may be coupled to the electrical terminal 420 by any suitable mechanism now known or hereafter developed. For example, in some embodiments, the electrical terminal 420 may include a tab 424 extending therefrom. The spring clamp 450, and more particularly, the first leg 452 of the spring clamp 450, may include an opening for receiving the tab 424 (e.g., the spring clamp 450 may be positioned on the electrical terminal 420. The electrical terminal 420 including a tab 424, which the spring clamp 450 may rest on. Thus arranged, the spring clamp 450 is prevented from moving or sliding too far down the electrical terminal 420). In addition, the housing 410 of the wiring device 400 may include walls, surfaces, etc. to contact, hold, form pockets, etc. for receiving the spring clamp 450 during assembly to further secure the position of the spring clamp 450 within the housing 410. Moreover, additional tabs from the electrical terminal 420 may be utilized to limit any lateral movement of the spring clamp 450.

In use, the electrical wire receiving space S (e.g., opening defined by the inner edge or surface 459 of the opening 458 formed in the third leg 456 of the spring clamp 450 and the electrical terminal 420) may be arranged and configured to receive a plurality different wire gauges and types. For example, the electrical wire receiving space S may be arranged and configured to receive 8-gauge, 10-gauge, 12-gauge, 14-gauge, etc. In addition, the electrical wire receiving space S may be arranged and configured to receive stranded wire, solid wire, etc.

In addition, in some embodiments, as previously described, the inner edge or surface 459 of the opening 458 in the third leg 456 of the spring clamp 450 may be sharpened (e.g., contain a sharpened edge portion) so that the inner edge or surface 459 may be arranged and configured to “cut” (e.g., engage or bite) into the electrical wire 125 to ensure contact is retained (e.g., to provide additional retention force in maintaining the wire 125 in the electrical wire receiving space S in the first or closed position). However, this is but one configuration and other configurations are envisioned. For example, the inner edge or surface 459 may have any suitable shape such as a flat surface parallel to the wire axis, a “V” shape, a curved surface (either concave or convex with respect to the wire axis), etc. In use, the edge or surface 459 may be configured to “bite” into the electrical wire 125.

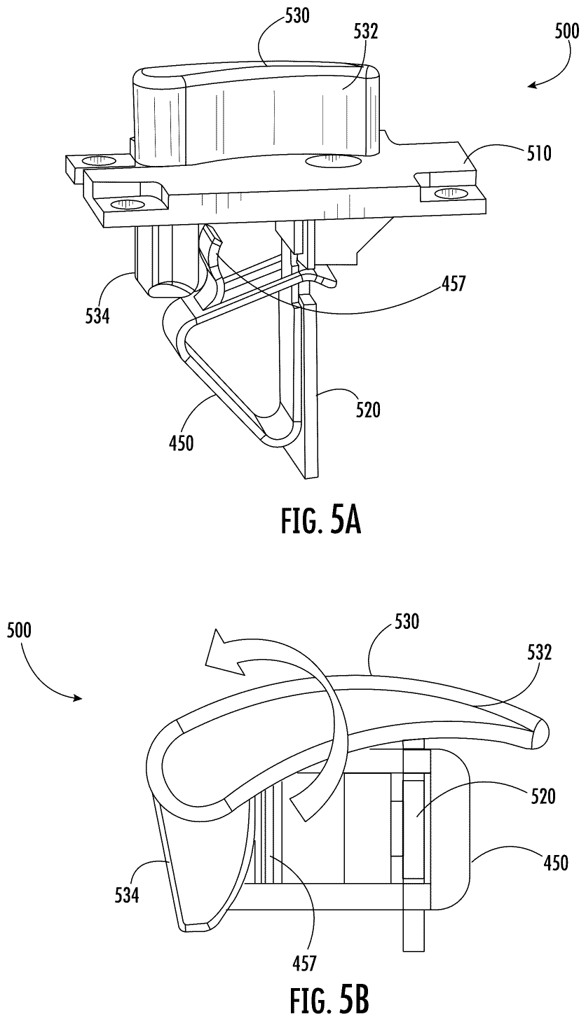

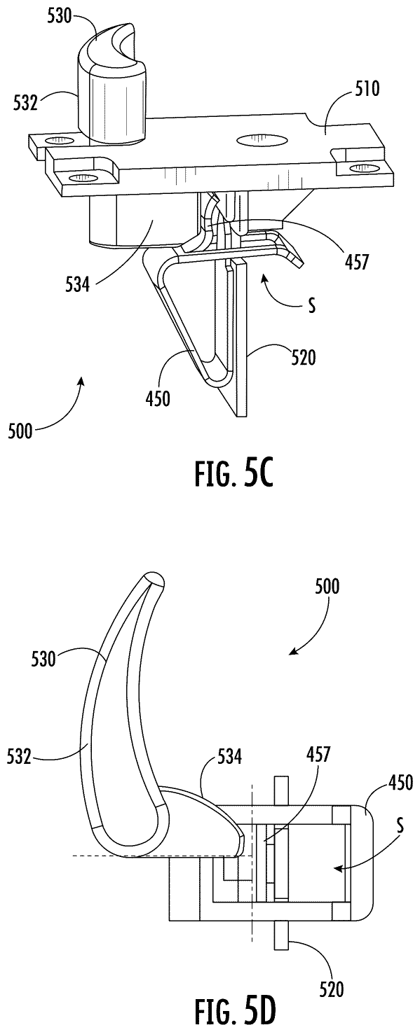

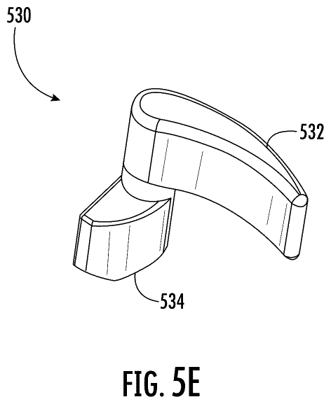

Referring to FIGS. 5A-5E, an alternate example embodiment of a wiring device 500 in accordance with one or more features of the present disclosure will be described. As will be appreciated by one of ordinary skill in the art, the wiring device 500 may be any line voltage wiring device such as, for example, a plug, a connector, or the like as will be described in greater detail below. In use, the wiring device 500 incorporates the spring clamp 450 as previously described herein in connection with FIG. 3.

As illustrated, in some embodiments, the wiring device 500 includes a housing 510 such as, for example, housing 110 of wiring device 100, or housing portion (e.g., rear body portion or husk 712) of wiring device 700, or housing portion (e.g., rear body portion or husk 812) of wiring device 800, or the like. In addition, the wiring device 500 includes an electrical terminal 520 such as, for example, electrical terminal 120 positioned within housing 110, or electrical terminals or blades 716 positioned within wiring device 700, or electrical terminals or contacts 816 positioned within wiring device 800, or the like. Furthermore, the wiring device 500 includes a wire terminal including a lever 530 and a spring clamp such as, for example, spring clamp 450. In use, the lever 530 is moveable between a first or closed position (illustratively shown in FIGS. 5A and 5B) and a second or opened position (illustratively shown in FIGS. 5C and 5D). In some embodiments, as illustrated, the lever 530 may be radially pivotable. In use, as illustrated, the lever 530 extends from the housing 510 of the wiring device 500 so that, during installation, a user may move the lever 530 from the first or closed position to the second or opened position to insert the electrical wire 125 therein. Thereafter, once the electrical wire 125 has been inserted, the user may move the lever 530 from the second or opened position to the first or closed position.

In some embodiments, the lever 530 is rotatable between the first and second positions. In addition, in some embodiments, as illustrated, the lever 530 may include a cam 534 and a lever arm 532. The cam 534 may be substantially perpendicular relative to the lever arm 532 (e.g., the lever arm 532 may be orientated at an approximate ninety-degree angle relative to the cam 534 (e.g., the lever arm 532 and the cam 534 may be rotationally offset relative to each other by approximately ninety-degrees or some other suitable angle, although this is but one configuration)). Thus, as illustrated, the cam 534 may be orientated at an approximately ninety-degree angle relative to the longitudinal axis of the lever arm 532 thereby giving the lever 530 an approximate L-shaped configuration. Thus arranged, in use, by rotationally offsetting the cam 534 relative to the lever arm 532, space is saved thereby permitting more than three similarly configured terminals/terminations within the housing.

In use, the cam 534 is arranged and configured to contact the extended leg 457 of the spring clamp 450 so that when in the second or opened position, the cam 534 interacts with the extended leg 457 of the spring clamp 450 to enlarge the electrical wire receiving space S (e.g., the cam 534 contacts the extended leg 457 of the spring clamp 450 in the second or opened position causing the spring clamp 450 to open thereby creating or enlarging the electrical wire receiving space S to enable the user to install the electrical wire 125 into the electrical wire receiving space S when the lever arm 532 is rotated to the second or opened position).

In use, the lever 530 may be moved from the first or closed position to the second or opened position. In the second or opened position, the cam 534 contacts the upwardly extended leg 457 formed on the spring clamp 450 to displace or move the spring clamp 450, and in particular, the third leg 456 of the spring clamp 450 relative to the electrical terminal 520 of the wiring device 500. Thus arranged, the cam 534 causes the spring clamp 450 to open thereby creating or enlarging the electrical wire receiving space S to enable the user to install the electrical wire 125 into the electrical wire receiving space S.

Once the wire 125 is installed, the lever 530 may be rotated to the first or closed position. In the first or closed position, the cam 534 releases, or at least minimizes the contact force on, the extended leg 457 of the spring clamp 450 thereby enabling the spring clamp 450 to return to its initial, relaxed, or natural configuration. In the first or closed position, the inner edge or surface 459 of the spring clamp 450 compresses the electrical wire 125 against the electrical terminal 520.

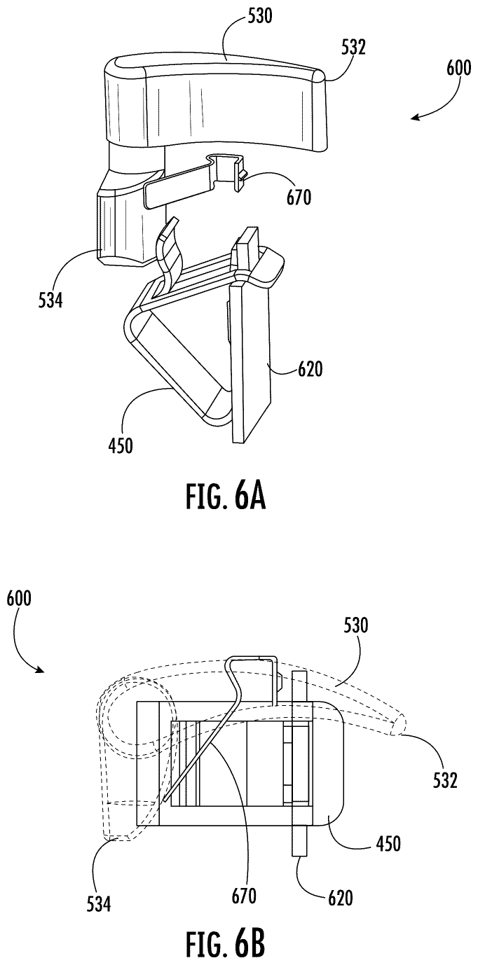

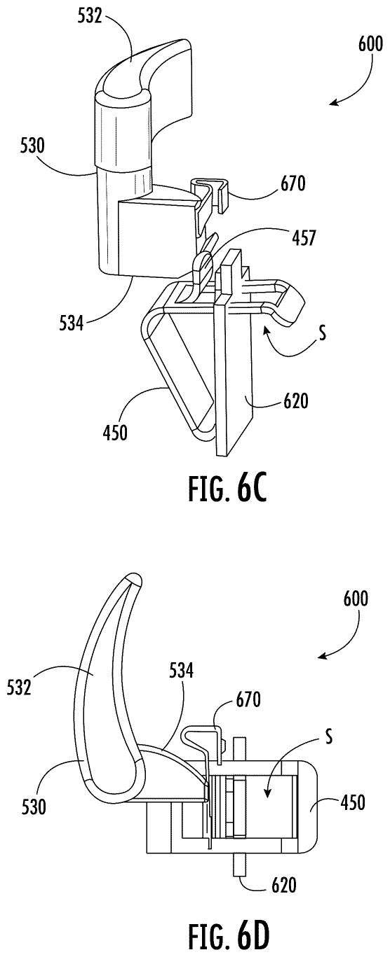

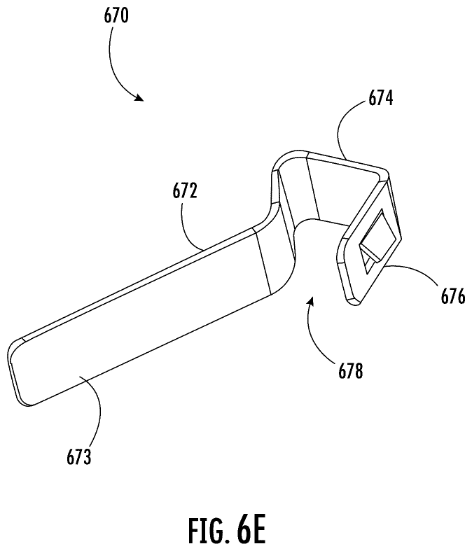

Referring to FIGS. 6A-6E, an alternate example embodiment of a wiring device 600 in accordance with one or more features of the present disclosure will be described. In use, the wiring device 600 is substantially similar to the previously described wiring device 500 except for the inclusion of a secondary mechanical spring (e.g., a secondary biasing spring or lever assist spring) 670 to bias the lever 530 to the first or closed position. In use, the secondary mechanical spring may be any suitable spring now known or hereafter developed such as, for example, a leaf spring, a coil spring, a cantilever spring, a compression spring, a torsion spring, a spiral spring, a Belleville spring, an arc spring, a conical spring, a disc spring, an extension spring, a flat spring, a helical spring, a ring spring, a serpentine spring, a tapered spring, and any suitable combinations thereof.

As illustrated, the wiring device 600 includes a housing (not shown) such as, for example, housing 110 of wiring device 100, or housing portion (e.g., rear body portion or husk 712) of wiring device 700, or housing portion (e.g., rear body portion or husk 812) of wiring device 800, or the like. In addition, the wiring device 600 includes an electrical terminal 620 such as, for example, electrical terminal 120 positioned within housing 110, or electrical terminals or blades 716 positioned within wiring device 700, or electrical terminals or contacts 816 positioned within wiring device 800, or the like. Furthermore, the wiring device 600 includes a wire terminal including a lever 530 and a spring clamp 450.

In accordance with one or more features of the present disclosure, the wiring device 600 may also include a secondary mechanical spring 670 arranged and configured to bias the lever 530 to the first or closed position. Thus arranged, the secondary mechanical spring 670 is arranged and configured to assist with maintaining the lever 530 in the first or closed position, and thus prevent, or at least inhibit, inadvertent actuation or movement of the lever 530 to the second or opened position. That is, in use, the secondary mechanical spring 670 is arranged and configured to act on the lever 530 (e.g., to apply a biasing force onto the lever 530) to ensure that when the lever 530 has traveled fully through its range of motion, there are no “dead zones” where the lever 530 is loose or likely to fall or move into the second or opened position (e.g., the secondary mechanical spring 670 ensures that when a user closes the lever 530, the lever 530 remains in the first or closed position). In other words, the lever 530 and the secondary mechanical spring 670, together may act similar to an over-center mechanism where the first and second positions are stable positions. When the lever 530 is at any point in its range of motion between the first and second positions, the lever 530 may be biased to “snap” to either the first or second positions.

In addition, in use, the secondary mechanical spring 670 may be arranged and configured to take up any slack caused by insertion of the electrical wire 125 into the electrical wire receiving space S defined by the spring clamp 450. The secondary mechanical spring 670 acts to bias the lever 530 to the first position when a wire 125 is inserted into the electrical wire receiving space S thereby assisting with removing any slack in the lever 530 occurring due to repositioning or reorientation of the spring clamp 450 due to the electrical wire 125 being positioned within the electrical wire receiving space S. In other words, the secondary mechanical spring 670 removes any displacement of the lever 530 from its first or closed position that would otherwise be created due to the presence of the electrical wire 125 within the electrical wire receiving space S.

In use, the secondary mechanical spring 670 may bias the lever 530 to the first or closed position. Thus arranged, in use, the lever 530 may be moved from the first or closed position to the second or opened position against the biasing force applied by the secondary mechanical spring 670. In the second or opened position, the electrical wire receiving space S is created or enlarged to enable a user to insert the electrical wire 125 into the electrical wire receiving space S (e.g., in the second or opened position, the electrical wire receiving space S may be enlarged a sufficient amount so that the electrical wire 125 can be freely inserted into the electrical wire receiving space S without undue interference or resistance). In some embodiments, at least a portion of the spring clamp 450 is moved away from the electrical terminal 620 thereby creating or enlarging the electrical wire receiving space S for the electrical wire 125 to be inserted when the lever 530 is in the second or opened position. The secondary mechanical spring 670 ensures, or at least minimizes, the likelihood that the lever 530 can move to the second or opened position inadvertently, which may otherwise cause the electrical wire 125 to free itself from the wiring device 600. In addition, the secondary mechanical spring 670 may assist with providing increased retention force to maintain the electrical wire 125 within the electrical wire receiving space S (e.g., in the first or closed position, with the electrical wire 125 positioned within the electrical wire receiving space S, the secondary mechanical spring 670 may provide increased retention force on the wire 125 against the electrical terminal 620).

The secondary mechanical spring 670 may have any suitable form and/or configuration to bias the lever 530 to the first or closed position. For example, the secondary mechanical spring 670 may include a first arm, leg, or segment 672, a second arm, leg, or segment 674, and a third arm, leg, or segment 676 (terms arm, leg, and segment used interchangeably herein without the intent to limit or distinguish). As illustrated, in some embodiments, the second arm 674 may be coupled to the first and third arms 672, 676. In addition, as illustrated, the first and third arms 672, 676 may be coupled to, extend from, etc. the respective ends of the second arm 674. Thus arranged, a space 678 is defined between the first and third arms 672, 676. In use, the secondary mechanical spring 670 may be coupled to the housing of the wiring device 600. Alternatively, the secondary mechanical spring 670 may be coupled to the electrical terminal 620 by, for example, positioning or clipping the electrical terminal 620 within the space 678 defined by the first and third arms 672, 676. Thus arranged, the secondary mechanical spring 670 may be directly coupled to, or in direct contact with, the electrical terminal 620.

In addition, as illustrated, in use, a second end or portion 673 (FIG. 6E) of the first arm 672 (e.g., the end or portion opposite the end coupled to the second arm 674) is arranged and configured to contact the lever 530, and more particularly, in some embodiments, the cam 534, to exert a force to bias the lever 530 to the first or closed position. For example, in some embodiments, the second end or portion 673 of the first arm 672 may contact the lever 530, and more particularly, the cam 534, to bias the lever 530 away from the electrical terminal 620. Thus, in use, the secondary mechanical spring 670 is arranged and configured to bias the lever 530 to the first or closed position. Alternatively, the secondary mechanical spring 670 may be provided in alternate forms.

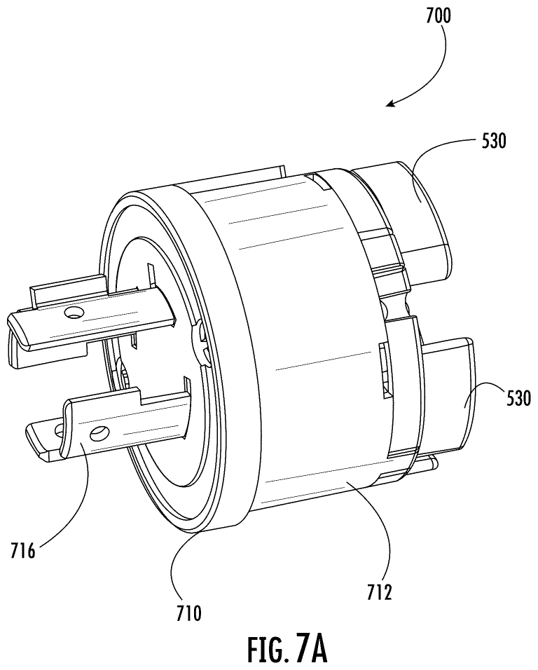

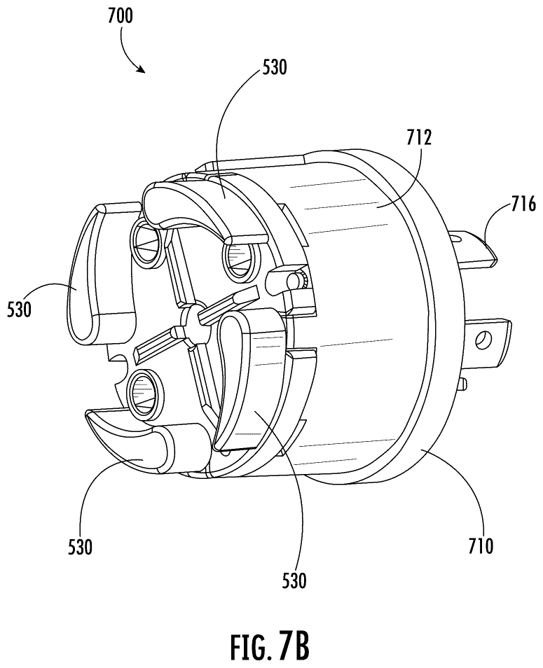

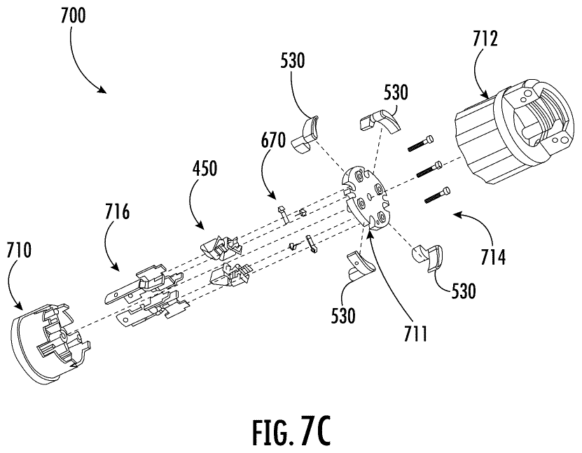

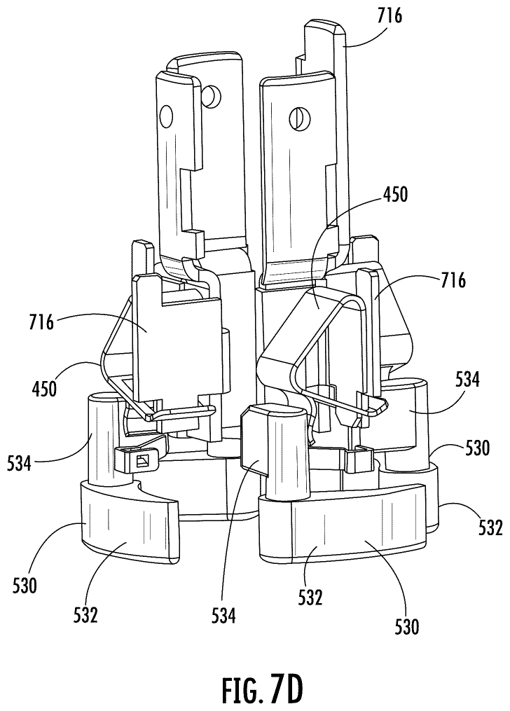

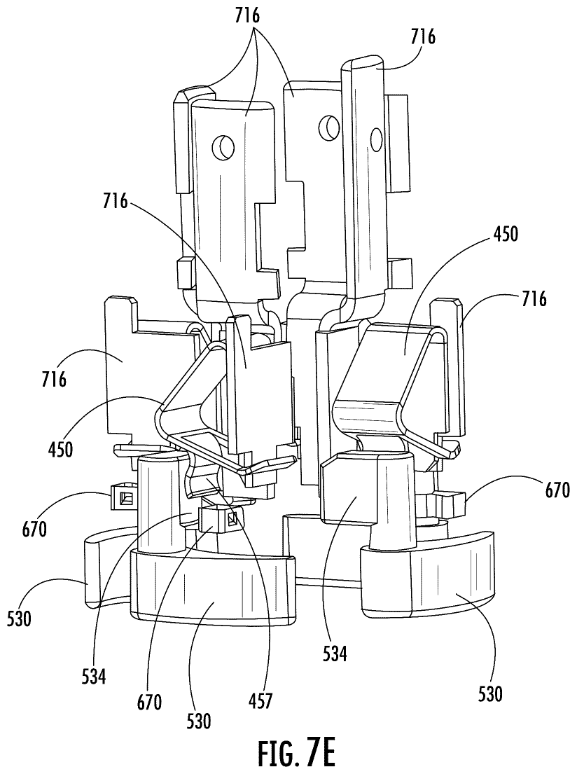

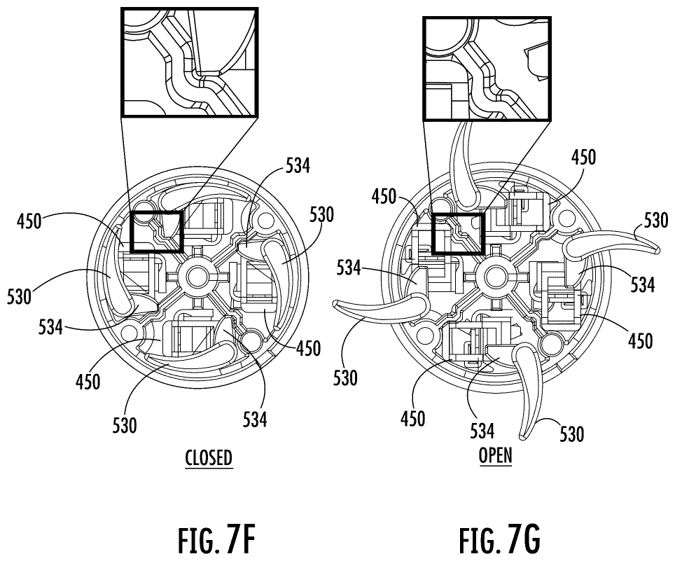

With reference to FIGS. 7A-7G, an example embodiment of a wiring device 700 incorporating the wire terminal (e.g., spring clamp 450, lever 530, and optional secondary mechanical spring 670) is disclosed. As illustrated, the wiring device 700 is in the form of a locking plug. In some embodiments, the locking plug includes a front body portion 710, a rear cover 711, a rear body portion or husk 712, and a plurality of screws or pins 714 for coupling the front body portion 710 and the rear cover 711. In addition, the locking plug includes a plurality of electrical terminals or blades 716 for mating with a corresponding connector. In use, the rear body portion or husk 712 includes an opening for receiving an electrical wire. In accordance with one or more features of the present disclosure, the locking plug includes four wire terminals, with each including a spring clamp 450, a lever 530, and optional secondary mechanical spring 670. As previously described, the wire terminals enable the user to quickly and easily couple the electrical wire to each of the electrical terminals or blades.

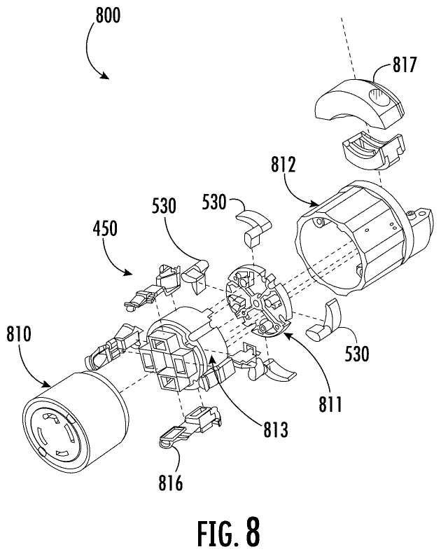

With reference to FIG. 8, an example embodiment of a wiring device 800 incorporating the wire terminal (e.g., spring clamp 450, lever 530, and optional secondary mechanical spring 670) is disclosed. As illustrated, the wiring device 800 is in the form of a connector arranged and configured to mate or couple with the locking plug illustrated in FIGS. 7A-7G. In some embodiments, the locking plug includes a front body portion 810, a rear cover 811, a rear body portion or husk 812, a mid-body 813, and a plurality of screws or pins (not shown) for coupling the front body portion 810 and the rear cover 811 together. In addition, the connector includes a plurality of electrical terminals or contacts 816 for mating with the electrical terminals or blades 716 of the locking plug.

In use, as illustrated, the rear body portion or husk 812 includes an opening and husk clamp 817 for receiving an electrical wire. In accordance with one or more features of the present disclosure, the connector includes four wire terminals, with each including a spring clamp 450, a lever 530, and optional secondary mechanical spring 670. As previously described, the wire terminals enable the user to quickly and easily couple the electrical wire to each of the electrical terminals or contacts.

As will also be appreciated by one of ordinary skill in the art, while the locking plug and connector illustrate a total of four wire terminals, different numbers of wire terminals (e.g., levers, spring clamps, etc.) may be used depending on the configuration and/or application of wiring device being utilized.

The foregoing description has broad application. While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments. Rather these embodiments should be considered as illustrative and not restrictive in character. All changes and modifications that come within the spirit of the invention are to be considered within the scope of the disclosure. The present disclosure should be given the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art. Unless otherwise defined, all technical terms used herein have the same meaning as commonly understood by one of ordinary skill in the art to which the disclosure belongs.

Directional terms such as top, bottom, superior, inferior, medial, lateral, anterior, posterior, proximal, distal, upper, lower, upward, downward, left, right, longitudinal, front, back, above, below, vertical, horizontal, radial, axial, clockwise, and counterclockwise) and the like may have been used herein. Such directional references are only used for identification purposes to aid the reader's understanding of the present disclosure. For example, the term “distal” may refer to the end farthest away from the medical professional/operator when introducing a device into a patient, while the term “proximal” may refer to the end closest to the medical professional when introducing a device into a patient. Such directional references do not necessarily create limitations, particularly as to the position, orientation, or use of this disclosure. As such, directional references should not be limited to specific coordinate orientations, distances, or sizes, but are used to describe relative positions referencing particular embodiments. Such terms are not generally limiting to the scope of the claims made herein. Any embodiment or feature of any section, portion, or any other component shown or particularly described in relation to various embodiments of similar sections, portions, or components herein may be interchangeably applied to any other similar embodiment or feature shown or described herein.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. Furthermore, references to “one embodiment” of the present disclosure are not intended to be interpreted as excluding the existence of additional embodiments that also incorporate the recited features.

In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present subject matter covers such modifications and variations as come within the scope of the appended claims and their equivalents.

As used herein, an element or step recited in the singular and proceeded with the word “a” or “an” should be understood as not excluding plural elements or steps, unless such exclusion is explicitly recited. It will be further understood that the terms “comprises” and/or “comprising,” or “includes” and/or “including” when used herein, specify the presence of stated features, regions, steps, elements and/or components, but do not preclude the presence or addition of one or more other features, regions, integers, steps, operations, elements, components and/or groups thereof.

The phrases “at least one,” “one or more,” and “and/or,” as used herein, are open-ended expressions that are both conjunctive and disjunctive in operation. The terms “a” (or “an”), “one or more” and “at least one” can be used interchangeably herein.

Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

The foregoing discussion has been presented for purposes of illustration and description and is not intended to limit the disclosure to the form or forms disclosed herein. For example, various features of the disclosure are grouped together in one or more embodiments or configurations for the purpose of streamlining the disclosure. However, it should be understood that various features of the certain embodiments or configurations of the disclosure may be combined in alternate embodiments or configurations. Moreover, the following claims are hereby incorporated into this Detailed Description by this reference, with each claim standing on its own as a separate embodiment of the present disclosure.

1. A wiring device, comprising:
a housing and an electrical terminal disposed at least partially within the housing; and
a wire terminal arranged and configured to mechanically and electrically secure a line-voltage AC electrical wire to the electrical terminal, the wire terminal including:
an actuator moveable between a first position and a second position; and
a spring clamp including an opening, the opening at least partially defining an electrical wire receiving space to selectively receive an electrical wire, the spring clamp including an extended leg extending therefrom, the extended leg configured to interact with the actuator;
wherein, in the second position, the actuator interacts and biases the extended leg so that a portion of the spring clamp moves with respect to the electrical terminal to enlarge the electrical wire receiving space to allow an electrical wire to be received therein; and
wherein, in the first position, the actuator allows the portion of the spring clamp to return to an initial configuration, the initial configuration arranged and configured to reduce the electrical wire receiving space, wherein if an electrical wire is present, the electrical wire is biased into contact with the electrical terminal to securely retain the electrical wire within the electrical wire receiving space and in contact with the electrical terminal.

2. The wiring device of claim 1, wherein the actuator is a rotary actuator arranged and configured to rotate between the first position and the second position.

3. The wiring device of claim 2, wherein the rotary actuator includes a lever arm and a cam, the cam being rotationally offset from the lever arm, the cam being arranged and configured to contact the extended leg of the spring clamp when the rotary actuator is in the second position.

4. The wiring device of claim 3, wherein, when the rotary actuator is in the first position, the cam exerts a reduced contact force on the extended leg of the spring clamp to allow the spring clamp to bias the electrical wire into contact with the electrical terminal.

5. The wiring device of claim 3, wherein, when the rotary actuator is in the first position, the cam exerts no contact force on the extended leg of the spring clamp to allow the spring clamp to bias the electrical wire into contact with the electrical terminal.

6. The wiring device of claim 3, wherein the cam is oriented an approximate ninety-degree angle relative to the lever arm.

7. The wiring device of claim 3, further comprising a secondary mechanical spring arranged and configured to contact the cam of the rotary actuator to bias the rotary actuator into the first position.

8. The wiring device of claim 2, wherein the spring clamp further includes a first leg arranged and configured to contact the electrical terminal, a second leg having a first end coupled to an end of the first leg, and a third leg coupled to a second end of the second leg, the extended leg extending away from the third leg.

9. The wiring device of claim 8, wherein the electrical terminal includes a tab formed thereon, the first leg includes an opening, the opening of the first leg arranged and configured to receive the tab to couple the spring clamp to the electrical terminal.

10. The wiring device of claim 8, wherein the third leg includes the opening of the spring clamp, the opening of the spring clamp defining an inner surface, the inner surface arranged and configured to contact the electrical wire when in the first position.

11. The wiring device of claim 10, wherein the inner surface of the opening of the spring clamp includes a sharpened edge portion arranged and configured to engage the electrical wire.

12. The wiring device of claim 10, wherein a segment of the first leg extends through the opening of the spring clamp formed in the third leg.

13. The wiring device of claim 10, wherein moving the extended leg moves the third leg relative to the first leg thereby increasing the size of the electrical wire receiving space.

14. The wiring device of claim 13, wherein, in the first position of the actuator, a force applied by the actuator on the extended leg decreases so that the spring clamp returns towards its initial configuration.

15. The wiring device of claim 2, wherein the spring clamp further includes a plurality of segments including first and second segments, wherein:
the first segment is arranged and configured to contact the electrical terminal; and
the second segment is coupled to the first segment and the extended leg.

16. The wiring device of claim 15, wherein the plurality of segments further comprises a third segment, wherein the second segment is coupled to the first segment via the third segment.

17. The wiring device of claim 1, wherein the actuator is a lever, the lever being pivotable between the first and second positions.

18. The wiring device of claim 1, wherein the electrical wire receiving space is arranged and configured to receive an electrical wire having one of a plurality different wire gauges selected from No. 8 AWG, No. 10 AWG, No. 12 AWG, and No. 14 AWG.

19. The wiring device of claim 1, further comprising a secondary mechanical spring arranged and configured to bias the actuator into the first position.

20. The wiring device of claim 1, wherein the electrical terminal further comprises a plurality of electrical terminals and the wiring device is selected from one of:
a plug, wherein each terminal comprises a blade; or
a connector, wherein each terminal comprises a contact.

21-33. (canceled)
